(19) United States
(12) Patent Application Publication
(10) Pub. No.: US 2026/0320989 A1
(43) Pub. Date: Oct. 15, 2026

(54) METHOD FOR GENERATING A DISCRIMINATIVE LARGE VISION-LANGUAGE MODEL

(71) Applicant: SAMSUNG ELECTRONICS CO., LTD., Suwon-si (KR)

(72) Inventors: Yassine OUALI, Chertsey (GB); Ioannis MANIADIS, Chertsey (GB); Georgios TZIMIROPOULOS, Chertsey (GB); Anestis ZAGANIDIS, Chertsey (GB); Alexandros XENOS, Chertsey (GB); Adrian BULAT, Chertsey (GB); Brais Martinez ALONSO, Chertsey (GB)

(73) Assignee: SAMSUNG ELECTRONICS CO., LTD., Suwon-si (KR)

(21) Appl. No.: 19/633,164

(22) Filed: Mar. 30, 2026

Related U.S. Application Data
(63) Continuation of application No. PCT/KR2025/017996, filed on Nov. 5, 2025.

(30) Foreign Application Priority Data
Nov. 12, 2024 (GR) 20240100796
Oct. 21, 2025 (EP) 25210040.9

(51) Int. Cl. G06V 10/778; G06V 20/40

(52) U.S. Cl. CPC G06V 10/778; G06V 20/41

(57) ABSTRACT

A method for generating LVLM is provided. The method may comprise obtaining a pre-trained LVLM for generating at least one of images or text. The method may comprise obtaining a training dataset comprising input images. For each input image of the training dataset having the short caption, the method may comprise training the pre-trained LVLM to perform discriminative image-based tasks, by: generating, using the pre-trained LVLM, an image embedding for the input image and a text embedding for the short caption and minimising a contrastive training loss using the image embedding and the text embedding. For each input image of the training dataset having the long caption, the method may comprise training the pre-trained LVLM to perform discriminative image-based tasks, by: generating, using the LLM, a predicted long caption for the input image and minimising an autoregressive training loss between the long caption and the predicted long caption.

### CROSS-REFERENCE TO RELATED APPLICATION(S)

This application is a continuation application of International Application No. PCT/KR2025/017996, filed on Nov. 5, 2025, which is based on and claims priority to Greek patent application No. 20240100796, filed on Nov. 12, 2024, in the Hellenic Industrial Property Organization, and European Patent Application No. 25210040.9, filed on Oct. 21, 2025, in the European Patent Office, the disclosures of which are incorporated by reference herein in their entireties.

### BACKGROUND

### 1. Field

The present application generally relates to a method for generating a discriminative large vision-language model. In particular, the present application provides a method for transforming a generative large vision language model, LVLM, into a discriminative large vision language model, LVLM.

### 2. Description of Related Art

Contrastively-trained Vision Language Models (VLMs) (e.g., CLIP) have become the predominant direction for vision-language representation learning, exhibiting remarkable zero-shot abilities. However, the great success of these models in many vision-language and vision tasks, even in a zero-shot manner, “sweeps under the rug” some of their important limitations. Specifically, such models struggle to exhibit advanced language understanding capabilities, suffer from a limited understanding of compositionality, and manifest a bag of words behaviour. (A bag of words behaviour is where a model uses frequency of words to represent text, but in doing so, loses the semantic meaning and context of the text.) For example, even with bag of words behaviour, VLMs have shown remarkable zero-shot retrieval accuracy on the Flickr and COCO datasets. Still, they perform poorly on a simple word order permutation task on the same datasets. Unfortunately, these issues persist even when the model and the dataset size increase.

Concomitantly, inspired by the success of LLMs in acting as generalist assistants, a series of works combine pretrained vision encoders and LLMs to construct Large Vision-Language Models (LVLMs) capable of performing interactive multi-modal conversations. Among others, these models have been shown capable of exhibiting strong reasoning and vision-language understanding capabilities, offering fine-grained and detailed responses. However, they are trained with a next-token prediction loss in an autoregressive manner, which appears less suitable for direct utilization in discriminative image-text tasks (e.g., image-text retrieval).

A generative LVLM is one which can generate new images and/or new text from an input prompt (that may be an image or text). For example, a generative LVLM may be able to generate a new image given an input image, or may be able to generate a description or caption for the input image. A generative LVLM could generate new photos of animals that look like real animals.

A discriminative LVLM is one which can discriminate between different types of input instances. For example, a discriminative LVLM could distinguish between a dog and a cat in input images.

The present applicant has therefore identified the need for improved LVLMs.

### SUMMARY

According to an aspect of the disclosure, a method for generating a large vision language model, LVLM is provided. The method may comprise obtaining a pre-trained LVLM for generating at least one of images or text, wherein the pre-trained LVLM may comprise a large language model, LLM, and a vision encoder. The method may comprise obtaining a training dataset comprising input images, wherein each input image may have at least one text caption and wherein each text caption may be either a short caption or a long caption. For each input image of the training dataset having the short caption, the method may comprise training the pre-trained LVLM to perform discriminative image-based tasks, by: generating, using the pre-trained LVLM, an image embedding for the input image and a text embedding for the short caption and minimising a contrastive training loss using the image embedding and the text embedding. For each input image of the training dataset having the long caption, the method may comprise training the pre-trained LVLM to perform discriminative image-based tasks, by: generating, using the LLM, a predicted long caption for the input image and minimising an autoregressive training loss between the long caption and the predicted long caption. The method, wherein the contrastive training loss and the autoregressive training loss may be minimised jointly.

According to an aspect of the disclosure, an electronic device including memory storing instructions and at least one processor operatively coupled to the memory and comprising processing circuitry is provided. The at least one processor may individually or collectively execute the instructions to cause the electronic device to obtain a pre-trained LVLM for generating at least one of images or text, wherein the pre-trained LVLM may comprise a large language model, LLM, and a vision encoder. The at least one processor may individually or collectively execute the instructions to cause the electronic device to obtain a training dataset comprising input images, wherein each input image may have at least one text caption and wherein each text caption may be either a short caption or a long caption. For each input image of the training dataset having the short caption, the at least one processor may individually or collectively execute the instructions to cause the electronic device to train the pre-trained LVLM to perform discriminative image-based tasks, by: generate, using the pre-trained LVLM, an image embedding for the input image and a text embedding for the short caption and minimise a contrastive training loss using the image embedding and the text embedding. For each input image of the training dataset having the long caption, the at least one processor may individually or collectively execute the instructions to cause the electronic device to train the pre-trained LVLM to perform discriminative image-based tasks, by: generate, using the LLM, a predicted long caption for the input image and minimise an autoregressive training loss between the long caption and the predicted long caption. The electronic device, wherein the contrastive training loss and the autoregressive training loss may be minimised jointly.

According to an aspect of the disclosure, a computer-readable storage medium storing instructions is provided. The instructions, when executed by at least one processor, may cause the at least one processor to perform the method corresponding.

### BRIEF DESCRIPTION OF THE DRAWINGS

Implementations of the present techniques will now be described, by way of example only, with reference to the accompanying drawings, in which:

FIG. 1 illustrates a block diagram showing the overall VladVA framework of the present techniques according to an embodiment of the disclosure;

FIG. 2 illustrates graphs of entropy of the output probability distribution at the next-to-be-predicted token location according to an embodiment of the disclosure;

FIG. 3 illustrates graphs of cumulative variance of the image and text embedding matrices over a set of 50 prompts according to an embodiment of the disclosure;

FIG. 4 illustrates a diagram showing top-k next-to-be-predicted tokens before and after VladVA fine-tuning according to an embodiment of the disclosure;

FIG. 5 illustrates a graph showing image and text retrieval score on Flickr30k over a set of 50 image-text prompts ordered by their entropy scores according to an embodiment of the disclosure;

FIG. 6 illustrates example templates used during training according to an embodiment of the disclosure;

FIG. 7 illustrates a table showing results of experiments to compare zero-shot text-image retrieval accuracy according to an embodiment of the disclosure;

FIG. 8 illustrates a table showing results of experiments to compare the present techniques with state-of-the-art, performed on the SugarCrepe compositionality benchmark according to an embodiment of the disclosure;

FIG. 9 illustrates a table showing results of experiments to compare the present techniques with state-of-the-art, performed on the SugarCrepe++ compositionality benchmark according to an embodiment of the disclosure;

FIG. 10 illustrates a table showing impact of adaptation components and AR loss according to an embodiment of the disclosure;

FIG. 11 illustrates a table showing impact of training data size according to an embodiment of the disclosure;

FIG. 12 illustrates a flowchart of example operations of a method for generating a discriminative large vision language model, LVLM, for performing image-based tasks according to an embodiment of the disclosure;

FIG. 13 illustrates a flowchart of example operations to perform parts of the contrastive training according to an embodiment of the disclosure;

FIG. 14 illustrates a flowchart of example operations to perform parts of the autoregressive training according to an embodiment of the disclosure;

FIG. 15 illustrates a flowchart of example operations of a method for using a trained discriminative large vision language model, LVLM, on an electronic device according to an embodiment of the disclosure; and

FIG. 16 illustrates a block diagram of a system for fine-tuning a pre-trained LVLM and using the fine-tuned LVLM according to an embodiment of the disclosure.

FIGS. 17A and 17B illustrate a block diagram of example application using the VladVA according to an embodiment of the disclosure.

FIG. 18 illustrates a flowchart of a method for training the VladVA according to an embodiment of the disclosure.

FIGS. 19A and 19B illustrate a flowchart of a method for data and model preparation according to an embodiment of the disclosure.

FIG. 20 illustrates a flowchart of a method for a preparation module of the VladVA according to an embodiment of the disclosure.

FIG. 21 illustrates a flowchart of a method for an optimization module of the VladVA according to an embodiment of the disclosure.

### DETAILED DESCRIPTION

In a first aspect of the present techniques, there is provided a computer-implemented method for generating a discriminative large vision language model, LVLM, for performing image-based tasks, the method comprising: obtaining a pre-trained generative LVLM for generating images and/or text, wherein the pre-trained generative LVLM comprises: a large language model, LLM, and a vision encoder; obtaining a training dataset comprising input images, wherein each input image has at least one text caption and wherein each text caption is either a short caption or a long caption; and training the pre-trained generative LVLM to perform discriminative image-based tasks, by: for each input image of the training dataset having a short caption: generating, using the LVLM, an image embedding for the input image and a text embedding for the short caption; and minimising a contrastive training loss using the generated image embedding and text embedding; and for each input image of the training dataset having a long caption: generating, using the LLM, a predicted long caption for the input image; and minimising an autoregressive training loss between the long caption for and the predicted long caption; wherein the contrastive training loss and autoregressive training loss are minimised jointly.

Advantageously, the present techniques overcome the problems with existing vision-language models and provide an LVLM which has enhanced language understanding and can be used for generative image-based tasks (e.g., image generation from text prompts) and discriminative image-based tasks (e.g., image retrieval or image description/captioning). The present techniques solve the problems by introducing two training losses-one based on short captions and one based on long captions. As explained in more detail below, the short captions may be used to ensure that the LVLM is able to correctly understand images, by ensuring a text embedding produced by the LLM for the short caption is similar to/substantially matches an image embedding produced by the LLM (aided by the vision encoder). Thus, the LLM may be trained to understand both text and image features. The long captions may be used to ensure that the LVLM does not exhibit bag of words behaviour and may have better semantic understanding of images. By optimising both losses jointly, the resulting trained LVLM may be able to capture and summarise coarse details in images as well as capture and understand finer details in images.

The terms “short caption” and “long caption” may be relative terms which refer to the number of tokens in each caption. Tokens may be whole words, characters, or sub-words, which are analysed separately by LLMs. It will be understood that the long caption contains more tokens than the short captions. A non-limiting example is a short caption having up to 30 tokens and a long caption having over 100 tokens.

An embedding may be a representation of values or objects, like text, images or audio, that can be understood and processed by machine learning models. An embedding usually takes the form of a vector, and thus the terms “embedding” and “embedding vector” are used interchangeably herein. An embedding is therefore a mathematical representation of a data item (e.g. text, image, video, audio, etc.), and may represent some or all of the content of the data item. For example, an embedding may represent the semantic meaning of a data item. Embeddings make it possible for machine learning models to understand the relationships between different data items. Embeddings are normally analysed within embedding space, e.g., a mathematical space in which similar items are positioned closer to one another than less similar items. For example, if embedding A for data item A is close to embedding B for data item B in embedding space, then data item A and data item B are similar in some way.

A vision encoder may be a neural network model that is able to process an input image and output a single vector representing the visual content of the input image. An example vision encoder is the CLIP encoder.

The step of generating an image embedding for the input image may comprise: inputting, into the LLM, the input image together with a first prompt, wherein the first prompt causes the LLM to generate a first short summary of the input image; generating, using the LLM, the first short summary of the input image; and generating, using the LLM, an image embedding for the first short summary. That is, the image embedding, fᵥ, may be obtained by passing the input image alongside a handcrafted first (image) prompt through the LVLM and taking the output representation of the last token.

The first prompt may be, for example “in one word, describe the image”. Thus, inputting the input image together with a first prompt may comprise: inputting the input image together with a first prompt to generate a first single word summary of the input image.

Typically, it may not be possible to input the first prompt and image directly into the LLM and get good results. It may instead be necessary to input an initial image embedding into the LLM together with the first prompt, so that the LLM is operating on an embedding that it can understand, rather than a raw image that it may not understand. Thus, inputting the input image may comprise inputting an initial image embedding for the image into the LLM.

Preferably, the initial image embedding may be generated using the part of the LVLM that is good at processing images, e.g., the vision encoder. However, the LLM may not be able to readily understand an embedding produced by a vision encoder because the embedding is based on image features and is therefore a representation in vision/image space, but the LLM operates in text space. Thus, the method may further comprise generating the initial image embedding by: generating, using the vision encoder, a vision embedding for the input image, wherein the vision embedding encodes vision features extracted from the input image by the vision encoder and wherein the vision embedding is in a vision embedding space; and converting, using a projector module of the LVLM, the vision embedding from the vision embedding space into the initial image embedding in a textual embedding space. Accordingly, the projector module may help the LLM to understand the output from the vision encoder.

Thus, the steps to generate an image embedding, fᵥ, that encapsulates features of the image have been described. For the contrastive training, it is also necessary to generate a text embedding, fₜ, that encapsulates features of the short caption associates with the image. The goal of the contrastive training may be to ensure that the image and text embeddings for image-text pairs are close to each other in textual embedding space.

When the text caption is a short caption, generating a text embedding for the short caption may comprise: inputting, into the LLM, the short caption together with a second prompt to generate a second short summary of the short caption; generating, using the LLM, the second short summary of the short caption; and generating, using the LLM, a text embedding for the second short summary. Thus, the LLM does not generate a text embedding for the short caption itself, but for a summary based on the short caption.

The second prompt may be, for example “in one word, describe the text”. Thus, inputting the short caption together with a second prompt may comprise: inputting the short caption together with a second prompt to generate a second single word summary of the short caption.

Generally speaking, the step of minimising a contrastive training loss, [symbol] , may comprise: calculating a similarity between the generated image embedding and text embedding for each image having a short caption; and minimising the contrastive training loss by adjusting parameters of the LLM to increase the calculated similarity between the generated image embeddings and text embeddings. In other words, the image and text embeddings must be close if they are semantically similar, and this is enforced using a symmetric image-text and text-image contrastive loss.

For the autoregressive training, it is desirable for the LLM to be able to predict a long caption for an input image, where a long caption for the input image already exists. That is, the training may be used to cause the LLM to generate a long caption that is substantially similar to the existing long caption, though the LLM is only provided with the image and not the existing long caption.

The step of generating, using the LLM, a predicted long caption for the input image may comprise: inputting, into the LLM, the input image together with a third prompt to generate a predicted long caption of the input image. The third prompt may be, for example “describe the image in detail”.

The long caption may be generated using a next-token prediction technique. Thus, it may be necessary to start the process using a <BOS> (beginning of sentence) indicator, which is used to signal the initial token for the start of generation. Thus, generating, using the LLM, a predicted long caption for the input image may comprise: selecting an initial token (<BOS>) for the predicted long caption based on the input image and the third prompt, wherein the predicted long caption comprises a sequence of a plurality of tokens; and predicting each subsequent token in the sequence for the predicted long caption based on the previous token in the sequence.

Generally speaking, minimising an autoregressive training loss, [symbol] , may comprise: minimising an autoregressive training loss by adjusting parameters of the LLM to increase a probability that each token in the predicted long caption matches each token in the long caption for the input image. In other words, the autoregressive training loss may enable the LLM to learn from long captions, by predicting each and every token correctly. The loss may be guided by the existing long caption for the input image. That is, it may be desirable for the existing long caption and the generated long caption to be similar.

In some cases, obtaining a training dataset comprising input images having text captions may comprise: obtaining a plurality of images; and generating the at least one caption for each image using at least one trained ML model. This may be the case when input images having text captions do not readily exist. How the captions may be generated to form the training dataset is described below with reference to the Figures.

In any case, the step of obtaining a training dataset comprising input images having text captions may comprise: obtaining a plurality of images, each image having a short caption that is up to 30 tokens in length, and/or a long caption that is greater than or equal to 200 tokens in length. It will be understood that the caption lengths may vary—the key is that there is a large difference between the short and long caption lengths to ensure effective training for both tasks.

Fine-tuning of a trained LVLM is generally computationally expensive because of the sheer number of parameters of the LVLM. Thus, the present techniques may utilise parameter-efficient training to reduce the computational time and energy required for the fine-tuning. This may be achieved by using low-rank adapters.

Generally speaking, a low-rank adapter, LoRA, may involve training and storing the additional weight changes of a model (which relate to adapting the model for a new, related task) in a matrix, while freezing all the already-learned/pre-trained model weights. LoRA may decompose the weight change matrix ΔW into two low-rank matrices A and B. Instead of directly training the parameters in ΔW, LoRA may train the parameters in the A and B matrices. The original pre-trained weight matrix of the model may be W0 with a dimension of d*d, and this may be frozen during model training for other tasks. The updated matrix may be ΔW with dimension d*d as well. The dimension of matrix A may be r*d, and the dimension of matrix B may be d*r. When training is completed, W0 (the original weights of the model) and ΔW (the changed weights of the model after training on a specific downstream task) will be stored separately. When a new input x enters the LoRA fine-tuned model to be processed by the model, x will be multiplied with W and ΔW separately to generate two vectors (of the same dimension). The two vectors may be summed coordinate-wise to generate the final output h, such that h=W0x+ΔWx=W0x+BAx. Thus, training LoRA adapters instead of training the LVLM directly may be computationally more efficient.

Thus, generating, using the LLM, an image embedding for the input image and a text embedding for the short caption may comprise using a low-rank adapter for the LLM. As a result, minimising a contrastive training loss using the generated image embedding and text embedding may comprise adjusting parameters of the low-rank adapter rather than the LVLM parameters directly.

Similarly, generating, using the LLM, a predicted long caption for the input image may comprise using a low-rank adapter for the LLM. As a result, minimising an autoregressive training loss between the long caption and the predicted long caption comprises adjusting parameters of the low-rank adapter.

Preferably, the same low-rank adapter may be used for both the contrastive training and the autoregressive training tasks. The only difference may be the inputs into the adapter for the two tasks.

In a second aspect of the present techniques, there is provided a server for generating a discriminative large vision language model, LVLM, for performing image-based tasks, the server comprising: at least one processor coupled to memory for: obtaining a pre-trained generative LVLM, wherein the pre-trained generative LVLM comprises: a large language model, LLM, and a vision encoder; obtaining a training dataset comprising input images, wherein each input image has at least one text caption and wherein each text caption is either a short caption or a long caption; and training the pre-trained generative LVLM to perform discriminative image-based tasks, by: for each input image of the training dataset having a short caption: generating, using the LVLM, an image embedding for the input image and a text embedding for the short caption; and minimising a contrastive training loss using the generated image embedding and text embedding; and for each input image of the training dataset having a long caption: generating, using the LLM, a predicted long caption for the input image; and minimising an autoregressive training loss between the long caption for and the predicted long caption; wherein the contrastive training loss and autoregressive training loss are minimised jointly.

The features described above with reference to the first aspect apply equally to the second aspect and therefore, for the sake of conciseness, are not repeated.

The server may comprise at least one processor coupled to memory and arranged for implementing the methods described herein. The memory may store instructions that, when executed by the at least one processor individually or collectively, cause the at least one processor to perform the methods described herein.

In a third aspect of the present techniques, there is provided a computer-implemented method for using a trained discriminative large vision language model, LVLM, on an electronic device, wherein the LVLM has been trained using the methods described herein (e.g., with reference to the first technique), the method comprising: obtaining a user query in relation to an image; generating, using the trained LVLM to process the user query, a response to the user query; and outputting the generated response.

One example task for the trained LVLM is to describe or caption images. This may be useful for many purposes, such as for helping visually-impaired people to navigate different situations. Therefore, image captioning may help to improve content accessibility for people by describing the images to them.

In this example, obtaining a user query in relation to an image may comprise obtaining an image and a user text query to describe the image. The method may comprise: generating, using the trained LVLM to process the user query, a long caption; and outputting the generated long caption to a display of the electronic device. In some cases, the generated long caption may be read out to the user via a speaker of the electronic device.

One example task for the trained LVLM is to retrieve or search for images based on a user query (e.g., “find pictures of my dog running in a park”). This may help users to find images they have captured and which are stored in their image stores/photo galleries. Many users have thousands of images, and so searching for them by viewing each image would be very time-consuming.

In this example, obtaining a user query in relation to an image may comprise obtaining a user text query to retrieve at least one image from a plurality of images stored on the electronic device. The method may comprise: generating, using the trained LVLM to process the user query, a text embedding for the user text query; searching the plurality of images to identify an image having an image embedding that is most similar to the generated text embedding; and outputting the identified image to a display of the electronic device.

In a fourth aspect of the present techniques, there is provided an electronic device for using a trained discriminative large vision language model, LVLM, on an electronic device, wherein the LVLM has been trained using the methods described herein, the electronic device comprising: at least one processor coupled to memory for: obtaining a user query in relation to an image; generating, using the trained LVLM to process the user text query, a response to the user query; and outputting the generated response.

The electronic device comprises at least one processor and memory storing instructions that, when executed by the at least one processor individually or collectively, cause the electronic device to perform the methods described herein.

The electronic device may further comprise: a user interface for receiving a user query; and a display.

The electronic device may be a constrained-resource device, but which has the minimum hardware capabilities to use a trained model. The electronic device may be a smart device. The electronic device may be a smartphone. A smartphone is an example of a smart device. The electronic device may be a smart appliance. A smart appliance is another example of a smart device. An example of a smart appliance is a smart television (TV), a smart fridge, a smart oven, a smart vacuum cleaner, a smart robotic device, and so on. More generally, the electronic device may be a constrained-resource device, but which has the minimum hardware capabilities to use a trained ML model and/or to train an ML model. The electronic device may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge, smart vacuum cleaner, smart lawn mower, smart oven, etc). It will be understood that this is a non-exhaustive and non-limiting list of example electronic devices.

The electronic device may further comprise: storage storing a plurality of images; and at least one user interface; wherein the at least one processor is configured for: obtaining, via the display, an image and a user text query to describe the image; generating, using the trained LVLM to process the user query, a long caption; and outputting the generated long caption to the user interface of the electronic device. The user interface may be a display and/or an audio output device/speaker.

The electronic device may further comprise: storage storing a plurality of images; and a display; wherein the at least one processor is configured for: obtaining, via the display, a user query to retrieve at least one image from the storage; generating, using the trained LVLM to process the user query, a text embedding for the user text query; searching the plurality of images in storage to identify an image having an image embedding that is most similar to the generated text embedding; and outputting the identified image to the display.

In a related aspect of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD or DVD-ROM, programmed memory such as non-volatile memory (e.g., Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, e.g., an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a defined (e.g., predetermined, predefined) target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Broadly speaking, embodiments of the present techniques provide a method for transforming a generative large vision language model, LVLM, into a discriminative large vision language model, LVLM.

The very recent (concurrent) work by Jiang et al is the first one to show that, with appropriate prompting, LVLMs can serve as zero-shot discriminative models. Importantly, Jiang et al advocates for a text-text optimization approach, stating that contrastive image-text fine-tuning has a detrimental effect on the model's performance. In contrast to Jiang et al, the present techniques provide a new training framework for discriminative image-text fine-tuning of LVLMs, aiming to convert the original generative LVLM into a discriminative one, thereby significantly enhancing its capability for image-text discrimination while preserving the compositional strengths of the original model.

In the present techniques, following the (independent) two-towers paradigm, the vision embeddings are produced by passing the image through the entire LVLM, and the text embeddings by passing the text through the LLM of the LVLM. Intuitively, for the vision embedding, the LLM acts as an information processor that refines the visual information while simultaneously aligning it with the textual representations. The present techniques are also referred to herein as VladVA: Vision-Language Adaptation for Discriminative Visual Assistant. Some of the contributions of the present techniques include:

A carefully designed optimization framework that utilizes image-text pairs of variable length and granularity for model training (e.g., both short and long captions). Using this data, the model may be trained with both contrastive and next-token prediction losses, which are both shown to be necessary for unlocking strong discrimination and compositionality capabilities. The present design choices are accompanied by ablation studies, which justify the necessity of the present framework's components.

To facilitate efficient training, it is shown that the model can be fine-tuned using a parameter-efficient adaptation method based on a combination of soft prompting and LoRA adapters. The positive impact of both components is shown.

Significant improvements over state-of-the-art two-tower models are reported (e.g., CLIP-like models) of similar size on standard image-text retrieval benchmarks (+4.7-7.0% gains in absolute terms). Moreover, notable gains on several vision-language understanding and compositionality benchmarks are reported (up to +15%).

Prior to explaining the present techniques in detail, some related works are described to provide context for understanding the advantages of the present techniques.

Large Vision Language Models (LVLMs): Inspired by breakthrough research in language modelling, a series of methods seek to combine pretrained LLMs and vision encoders to construct Large Vision Language Models (LVLMs) capable of processing image-text data jointly. The prevalent strategy consists in aligning the features produced by a pretrained vision encoder to the textual space assumed by a pretrained LLM using a projection module, LLaVA, following a two-stage alignment procedure. Follow-up works expand this to interleaved image-text data and multiple input crops while seeking to improve the model's efficiency.

Despite their strong generative and comprehension abilities, current LVLMs are primarily restricted to generative tasks. Only very recently, Jiang et al, inspired by the recent progress in NLP adapted a LLaVA-NEXT model to discriminative tasks using a contrastive-like loss and text data only. In contrast to Jiang et al, the present techniques introduce a training framework that learns from multi-turn image-text pairs (as opposed to text only) using a novel formulation that jointly combines a contrastive loss with a next-token prediction, reflecting the data characteristics and inducing a gradual representation buildup. Concurrently, VLM2Vec adapts an LVLM for multi-modal retrieval. However, it uses a different loss and training strategy (no generative loss, no short-long captions training, no soft prompting). The present aspect is compares with both E5-V and VLM2Vec, significantly improving upon their results despite using smaller/lighter models.

Discriminative Vision-Language Models: The prevalent approach for training Discriminative VLMs follows the two-tower contrastive approach pioneered by CLIP, whereby an image and text encoder are trained on web-collected image-text pairs to learn a joint multi-modal (e.g., vision and language) space. Subsequent works build upon CLIP by scaling the data, improving the architecture using late/early interactions or improving the training loss. Despite their remarkable zero-shot and representation learning abilities such models were shown to have significant shortcomings related to limited language understanding capabilities, including: lack of compositionality understanding, manifesting bag of words behaviour, struggling with spatial relations, being susceptible to typographical attacks. Recent works aim to address these shortcomings by constructing synthetic hard negatives or performing cross-modality attention. However, the former does not inherently change the model's behaviors and has been shown to potentially learn a series of shortcuts/artifacts. Meanwhile, the latter is impractical for deployment at scale, as, due to the interactions between the encoders, each new query incurs an additional inference for every image within the set.

To alleviate these shortcomings and improve the overall capabilities of such models, the present techniques depart from the prevalent approach of training VLMs using a contrastive loss and, instead, propose a new approach that seeks to convert generative LVLMs into discriminative models by adapting them using a newly proposed framework that combines generative and discriminative objectives.

### Method

The present techniques, referred to as VladVA (Vision-Language Adaptation for Discriminative Visual Assistant), provide a novel approach for discriminative fine-tuning of LVLMs that results in strong discriminative and compositional capabilities.

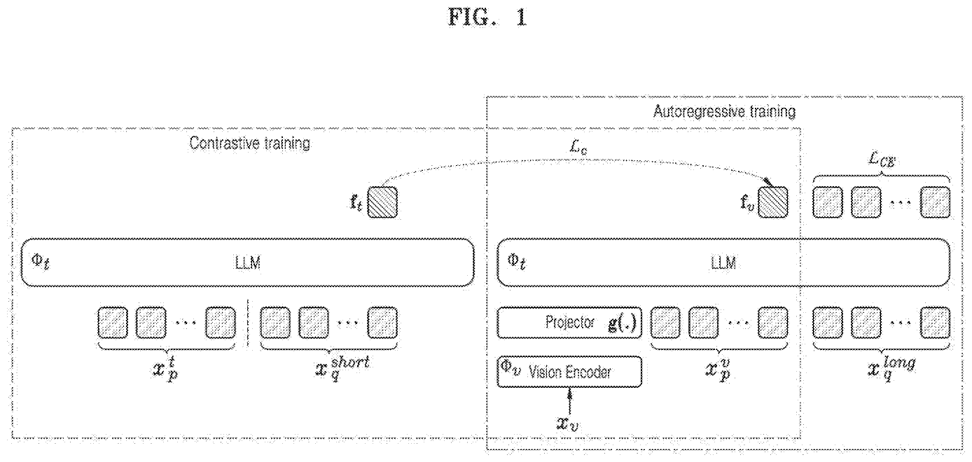

FIG. 1 illustrates a block diagram showing the overall VladVA framework according to an embodiment of the disclosure. A generative LVLM comprising an LLM and a vision encoder may be adapted into a discriminative model with the help of (1) a contrastive training loss, and (2) an autoregressive loss. The first training loss may be applied on image-text pairs with short (er) captions (as shown on the left of FIG. 1), encouraging the last token produced by both modalities to be discriminative. The second training loss, jointly optimized with the first one, may be applied only on longer captions and allows the model to learn fine-grained details (as shown on right of FIG. 1). The framework is now described in more detail.

LVLMs as zero-shot discriminative models: LVLMs consist of an LLM Φₜ, a vision encoder Φᵥ, and a module g that projects the vision features into the LLM's textual space. Once fine-tuned, such models can produce a textual answer xₐ=Φₜ(g(Φᵥ(xᵥ)), x_{q}) when presented with an input image xᵥ, and a text query (or prompt) x_{q}.

Despite being solely trained with an autoregressive next-token prediction loss on limited amounts of data (<5M), such models can act as multi-modal discriminative models in a zero-shot manner. To elicit this capability, the image embedding (on the right in FIG. 1)

$${f}_{v} = {Φ}_{t} ( g ( {Φ}_{v} ( {x}_{v} ) , {x}_{p}^{v} ) ) [ eos ]$$

may be obtained by passing the image alongside a handcrafted image prompt

$${x}_{p}^{v}$$

(e.g., “in one word, describe the image”) through the LVLM and taking the output representation of the last token. Analogously, the text embedding (on the left in FIG. 1)

$${f}_{t} = {Φ}_{t} ( {x}_{p}^{t} , {x}_{q} ) [ eos ]$$

may be produced by passing the handcrafted text prompt

$${x}_{p}^{t}$$

(e.g., “in one word, describe the text”) and input query x_{q} through the LLM (of the LVLM) and taking again the output representation of the last token. These particular tokens are referred to as “summary tokens” (summarizing image and text information, respectively). Note that, typically, the respective handcrafted prompts for the image

$$( {x}_{p}^{v} )$$

and text

$$( {x}_{p}^{t} )$$

modalities are different. Finally, the similarity between an image and a text query can be computed by taking the cosine similarity between the two: s=cos_sim(fᵥ, fₜ).

What makes a good prompt? Zero-shot adaptation by prompting already provides decent results despite the task changing from generation to discrimination. To shed some light, herein, the following are studied: (a) what makes a good prompt and (b) how can it be identified.

To answer these questions, a testbed consisting of 1,000 image-caption pairs from Flickr30k may be constructed, which is then used to evaluate the quality of various prompts. The prompts (50 image-text pairs in total) may be constructed using ChatGPT. Each prompt pair may be fed, alongside an image and its respective caption, through the LLaVA-1.5-7B model. For each image-prompt pair and caption-prompt pair, the token embedding may be extracted at the output position and the corresponding output probability distribution over the vocabulary. These may then be used to compute two metrics for each prompt: the average entropy of its output distributions and the cumulative variance of its embeddings.

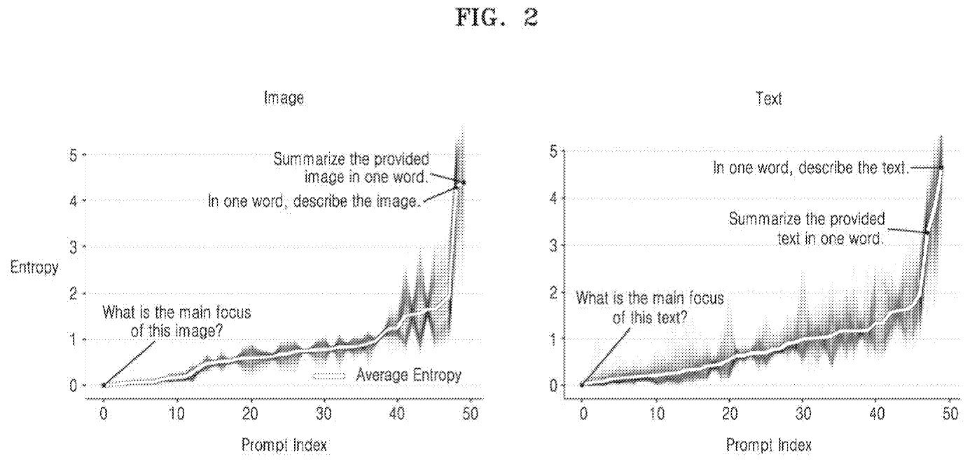

FIG. 2 illustrates graphs of entropy of the output probability distribution at the next-to-be-predicted token location using a LLaVA-1.5-7B for a set of 50 prompts for both images and captions according to an embodiment of the disclosure.

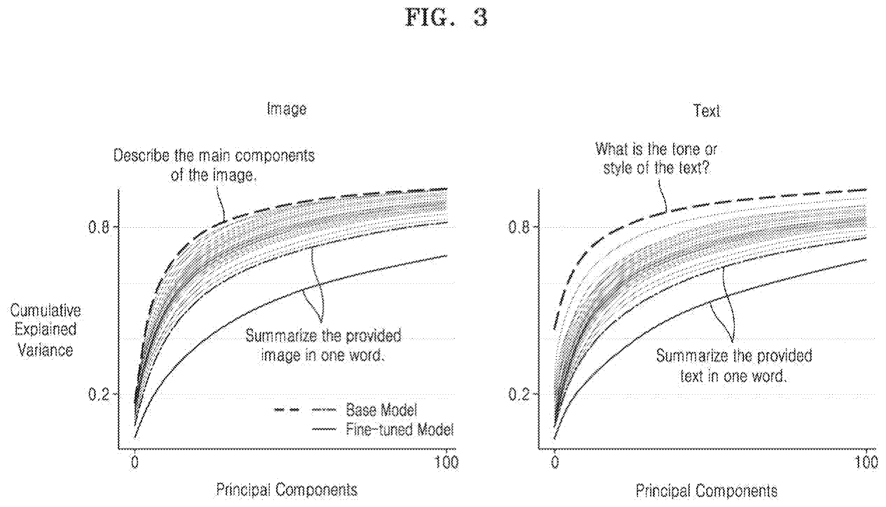

FIG. 3 illustrates graphs of cumulative variance of the image and text embedding matrices over a set of 50 prompts on Flickr30k according to an embodiment of the disclosure. Embeddings that capture more information about the input translate into a cumulative variance that requires more principal components to be explained, e.g., a higher-rank embedding matrix.

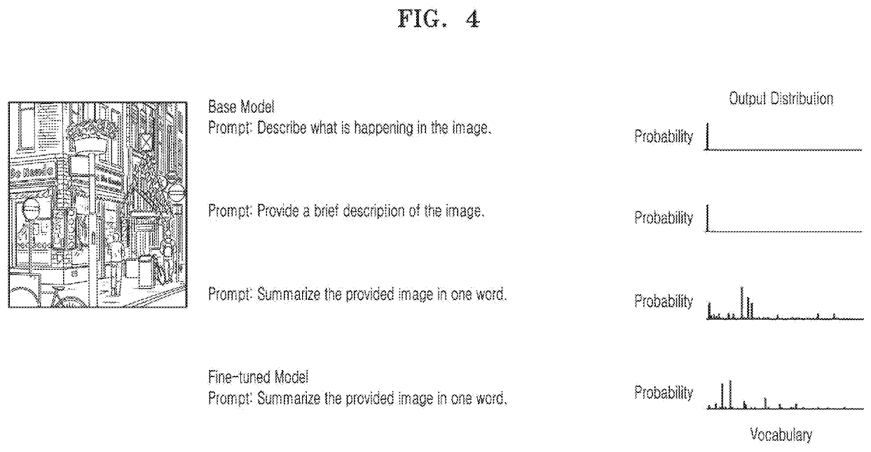

FIG. 4 illustrates a diagram showing top-k next-to-be-predicted tokens before and after VladVA fine-tuning (the present aspect) according to an embodiment of the disclosure. On the right, the output probability distribution is shown for each case.

### Base Model

Prompt: Describe what is happening in the image.

The (p=99.1%) There (p=0.6%) This (p=0.2%) Several (p=0.0%) Two (p=0.0%).

Prompt: Provide a brief description of the image.

The (p=95.9%) This (p=3.9%) There (p=0.1%) Out (p=0.1%) People (p=0.0%) Several (p=0.0%) Two (p=0.0%).

Prompt: Summarize the provided image in one word.

Street (p=25.5%) Bus (p=17.4%) Color (p=13.2%) Flow (p=5.1%) City (p=5.1%) Orange (p=4.7%) Check (p=4.6%) Red (p=4.2%) Store (p=3.8%) Urban (p=2.3%) Bou (p=2.1%) Green (p=2.1%) Beautiful (p=1.6%) Side (p=1.6%) Flor (p=1.2%)

### Fine-Tuned Model

Prompt: Summarize the provided image in one word.

pot (p=26.9%) street (p=12.0%) Green (p=8.6%) flowers (p=6.1%) sign (p=6.3%) shop (p=6.0%) Dutch (p=5.8%) green (p=5.2%) store (p=3.1%) red (p=2.8%) flower (p=2.7%) steets (p=2.3%) plant (p=2.1%) Flow (p=2.1%) cycl (p=1.5%) Amsterdam (p=1.5%) Netherlands (p=1.4%).

When using the best prompt (“Summarize the provided image in one word”), the representations of the next token can encode diverse and more discriminative information, making potentially better-quality embeddings. This behavior is further improved after VladVA fine-tuning.

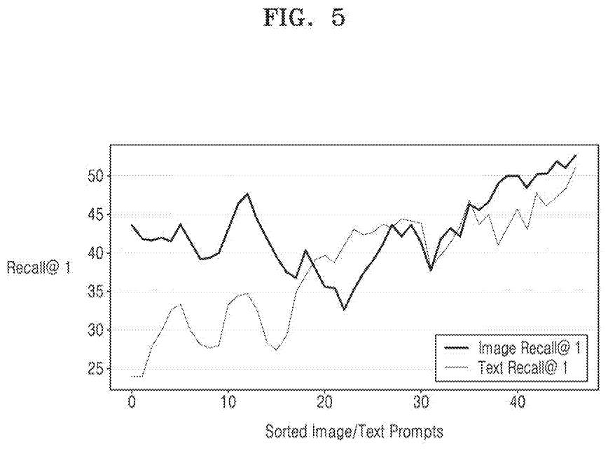

FIG. 5 illustrates a graph showing image and text retrieval score on Flickr30k over a set of 50 image-text prompts ordered by their entropy scores (FIG. 2) according to an embodiment of the disclosure. It is observed that prompts with high average entropy scores correlate positively with the zero-shot retrieval performance.

As FIGS. 2 and 4 show, when the model is prompted with sentences consisting of specific keywords, such as in a few words or in one word, the model is pushed to condense the information of the image or text in the next token, resulting in an output distribution with high entropy. More importantly, when investigating the generated embeddings, it is observed that higher entropy prompts result in embeddings with more spread-out cumulative variance, requiring more principal components to capture the same amount of variance, indicating an embedding matrix with a high rank (see FIG. 3). This translates into discriminative embeddings that can capture more information about the inputs, making them suitable for embedding tasks. The benefit of this behavior is illustrated in FIG. 5, which shows a positive correlation between prompts with high entropy scores and the model's zero-shot retrieval performance. Hence, the present aspect should seek to produce embeddings with a) spread-out variance and b) probability distributions over the vocabulary with increased entropy.

Discriminative fine-tuning of LVLMs: from generation to discrimination. Despite exhibiting surprising innate zero-shot abilities, LVLM's direct discriminative performance lags behind that of state-of-the-art contrastively trained VLMs. Hence, carefully designed frameworks are needed to unlock the full potential of such models. This is the very goal of the present work: to introduce a well-grounded adaptation/training framework that surfaces the discriminative image-text capabilities of a generative LVLM.

Notably, the present findings contradict those of the very recent work of Jiang et al, which found that contrastive image-text fine-tuning is detrimental and limits training to text-text contrastive learning alone. This highlights the importance of the present aspect, which overcomes such impediments and significantly boosts the discriminative performance of the model.

Having established the architecture above, the two other pillars are the data and training strategy.

Data strategy: The present Applicant argues for the importance of data diversity in terms of granularity and group captions according to their length: short captions (<30 tokens) and long captions (30-500 tokens). The short captions may capture coarse details and summarize image content teaching the model to discriminate with regard to high-level image information. Longer captions may capture finer image details and promote a better understanding of language concepts such as spatial relationships and compositionality. For a strong discriminative model, both are necessary. Therefore, for images missing either caption type, a BLIP2 captioner may be used to generate short captions and ShareGPT-4V may be used to generate long captions. This may enable both supervisory signals to be leveraged for training.

Training strategy: As demonstrated herein, the variable length of the training data poses its own challenges: unlike the case of short captions, where training using the well-studied contrastive loss performs well, it collapses for longer captions. This explains the proposed training strategy, whereby, to address this challenge, a hybrid training approach is proposed that combines a contrastive loss and a next-token prediction loss for discriminative adaptation. Finally, as full model fine-tuning is computationally expensive, a fine-tuning strategy is detailed that combines adapters with soft prompting.

Image-text contrastive alignment: Under a multi-modal contrastive formulation, the image and text representations, fᵥ and fₜ respectively, must be close if they are semantically similar and far apart otherwise, under a specified distance metric. At train time, this is enforced using a symmetric image-text and text-image contrastive loss, which, for a given mini-batch containing b randomly selected samples, can be described as:

$${ℒ}_{c} = \frac{1}{b} {\sum }_{k = 1}^{b} ( - log \frac{exp ( {s}_{v}^{k , k} )}{{\sum }_{j} exp ( {s}_{v}^{k , j} )} - log \frac{exp ( {s}_{t}^{k , k} )}{{\sum }_{j} exp ( {s}_{t}^{j , k} )} ) , \qquad ( 1 )$$

where

$${s}_{v}^{k , j} = cos\_sim ( {f}_{v}^{k} , {f}_{t}^{j} )$$

may denote the cosine similarity between the k-th image and the j-th caption (image-to-text), and similarity,

$${s}_{t}^{k , j}$$

the text-to-image similarity.

During training, the contrastive loss may be applied to the very same tokens used for the zero-shot evaluation, as they represent the optimal starting point for further fine-tuning. It is noted that the contrastive loss is mostly suitable for training using short captions

$${x}_{q}^{short}$$

(e.g., <30 tokens), like the ones typically used for CLIP pre-training. It is found that training the model using a contrastive loss on longer captions proves challenging. Hence, to address this, below a new formulation is studied and proposed that enables discriminative training on variable-length data.

Autoregressive training for learning discriminative LVLM representations: Until now, the modality-specific embeddings are obtained by taking the last token, prior to any generation, while the training is largely focused on short (e.g., <30 tokens) captions, mimicking the CLIP-style data used for contrastive training. This may contrast with the LLaVA-style autoregressive training, where long and highly descriptive captions (typically 200-500 tokens) are used to help the LVLM learn strong links between the vision and text domains, pay attention to fine-grained details, and develop strong reasoning and compositionality capabilities.

As noted earlier, directly using the long captions with the contrastive loss is ineffective, as, due to the high specificity of the long captions, the task is easy and nearly trivial to solve, with the loss going to 0 in just a few hundred iterations. To address this, the present techniques propose to instead apply the next-token prediction loss over the long captions:

$${ℒ}_{CE} = {\sum }_{i = 1}^{L} log {p}_{θ} ( {u}_{i} \vert {x}_{v} , {x}_{p}^{v} , {x}_{q , < i}^{long} ) , - 0.2 cm \qquad ( 2 )$$

where L may be the length of the long caption

$${x}_{q}^{long} ,$$

xᵥ the input image, and

$${x}_{p}^{v}$$

the prompt with prompts the model to describe the image in detail (e.g., “Describe the image in detail”), and pe the next-token probability distribution learned by the model.

Intuitively, this formulation may possess multiple advantages: (1) It allows the model to learn from long captions, as predicting each and every token correctly is a challenging task (as opposed to applying the contrastive loss to long captions); (2) The decoding process may encourage the condensation of information into the starting token used as a feature embedding; and (3) It may offer an avenue for retaining the generative capabilities of the model while strengthening its discriminative abilities.

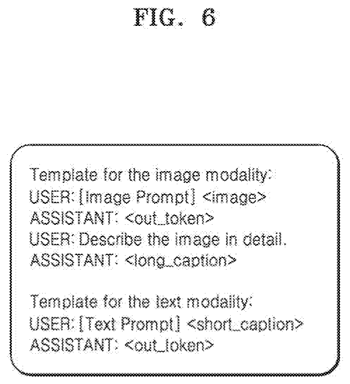

Overall training loss: As depicted in FIG. 1, the next-token prediction loss may be applied over the long captions and the contrastive loss over the short ones in a unified manner. During training, the templates presented to the LVLM for the image and text modality take the form shown in FIG. 6, with the contrastive loss applied on the output representations <out_token> for the image modality and <out_token> for the text modality. Concomitantly, the next-token prediction loss may be applied on the tokens of the <long_caption>. Generally, the short caption must be sufficiently different from the long caption to prevent shortcuts during training, a property that naturally emerges in the present case due to the difference in length and annotation procedure. Note that the distinction between long and short captions is made only during training. At test time, the model is used in discriminative mode.

Attention map between the summary and vision tokens shown for a set of heads. Notice that post-training, the attention maps densify. This behavioral change can be interpreted as follows: For generative tasks, at every step in the generation process, the model has the chance to look back at the vision tokens, selectively attending to the regions of interest at the current step. In contrast, in a discriminative setting, the model must compress all information present in the image within the summary token.

Parameter-efficient adaptation: As direct fine-tuning of the LVLM is costly, especially when maintaining a reasonably large batch size for contrastive learning, herein, parameter-efficient training is adopted with soft-prompting combined with LoRA adapters, both trained under the same loss formulation explained above.

Soft prompting was recently proposed as an efficient task-adaptation approach for both LLM and CLIP models, representing a direct departure from the prompt hand-crafting solution. Specifically, for a given input modality, e.g., image and text, a set of n modality (m)-specific learnable vectors

$$[ {v}_{1}^{m} , {v}_{2}^{m} , … , {v}_{n}^{m} ] , {v}_{i}^{m} ∈ {ℝ}^{C}$$

is defined with C denoting the model's vocabulary embedding size. These vectors can be inserted across the input sequence to adjust the model's behavior. In practice, the present techniques opt to replace the tokens belonging to the hard prompts

$$( e . g . , {x}_{p}^{v} and {x}_{p}^{t} )$$

with the learnable vectors, initializing their values with the embeddings of the handcrafted ones.

Adapter fine-tuning: While efficient, the representation power of the soft prompts is somewhat limited. Hence, following best practices, LoRA adapters may be attached to the linear layers located inside Φₜ. Such adapters offer a multifold advantage: lower memory requirements, reduced potential of overfitting during training, and no additional compute requirements during inference.

The model may be fine-tuned using these components. Importantly, both have a positive impact on overall accuracy.

How does the model's behavior change? Building upon the analysis above, it may be shown that the present training aspect elicits the following behavioural changes: (1) The attention map between the summary and vision tokens increases in density. (2) Both the entropy of the output distribution of the summary token and the spread of the cumulative variance of the embeddings increase.

The attention map densification may show that, for discriminative tasks, the model gathers evidence from all parts of the image in order to correctly encode the information therein. This is not needed for generation, as at every generation step, the model can “peak back” at the vision tokens and select the required information.

Entropy and cumulative variance: As shown in FIG. 3, the present aspect may result in models where the cumulative variance of the image and text embeddings is significantly more spread out, which translates into richer and better-aligned embeddings, capable of more accurately capturing fine-grained details. Additionally, the model may maintain the diversity of output distribution at the summary token, e.g., high entropy, as illustrated in FIG. 4.

### EXPERIMENTS

The present aspect is compared with the current state-of-the-art on two tasks of interest in a zero-shot manner: image-text retrieval and compositionality/language understanding.

Models compared: Comparison is made with state-of-the-art models based on the two-towers (independent) approach, which is practical for retrieval purposes and also followed by the present method. A wide variety of settings are covered: different models and model sizes, training data, training losses, etc.: CLIP (ViT-L)—the original CLIP trained with a contrastive loss on 400M image-text pairs; BLIP (ViT-L)—trained on over 120M samples using contrastive, captioning and image-text matching losses; BLIP2 (T5-XXL)—improved and scaled-up version of BLIP; OpenCLIP (ViT-G/14)—scaled-up version of CLIP trained on 2B samples; OpenCLIP (ViT-BigG/14), EVA-02-CLIP (ViT-E/14+), EVA-CLIP (8B) and EVA-CLIP (18B)—large contrastively trained models, with up to 18B parameters, fine-tuned from vision encoders trained with Masked Image Modeling (MIM); E5-V (LLaVA-Next-8B) and E5-V (LLaVA-1.5-7B)—LVLMs finetuned using a text-text contrastive loss. Depending on the task, additional specialized baselines are also included (e.g. NegCLIP for compositionality).

Training details: A LLaVA-1.5 (7B) model is used due to its popularity and simplicity (for other models, see supp. material). For LoRA adapters, the rank and a is set to 16. The number of soft prompts is aligned to the length of the tokenized hand-crafted prompt. Unless otherwise stated, the models are trained for 7 epochs, using a batch size of 1024, a learning rate of 1e-4, no weight decay, and AdamW optimizer with default values for β₁ and β₂. During training, the learning rate is decayed according to a cosine scheduler. Depending on the data configuration, up to 32 A100 GPUs are used. All of the models and training procedures were implemented using PyTorch and DeepSpeed.

The following training data is used: a 4M random subset of OpenImages, CC3M (~2.8M images), and ShareGPT-4V. As no captions are available for OpenImages, these are automatically labeled with 5 captions using BLIP2. During training, only one caption is sampled at a time. For longer captions, the ShareGPT-4V data is used directly, which is extended with synthetic short captions produced by BLIP2 in order to enable the training procedure proposed above. Similarly, CC3M is automatically annotated with long captions using ShareGPT4-V.

Zero-shot image-text retrieval: The present techniques were tested on the standard Flickr30k, MS-COCO and nocaps datasets, containing 1,000, 5,000 and 15,100 test samples respectively. For the latter, the results are simply averaged on the three partitions.

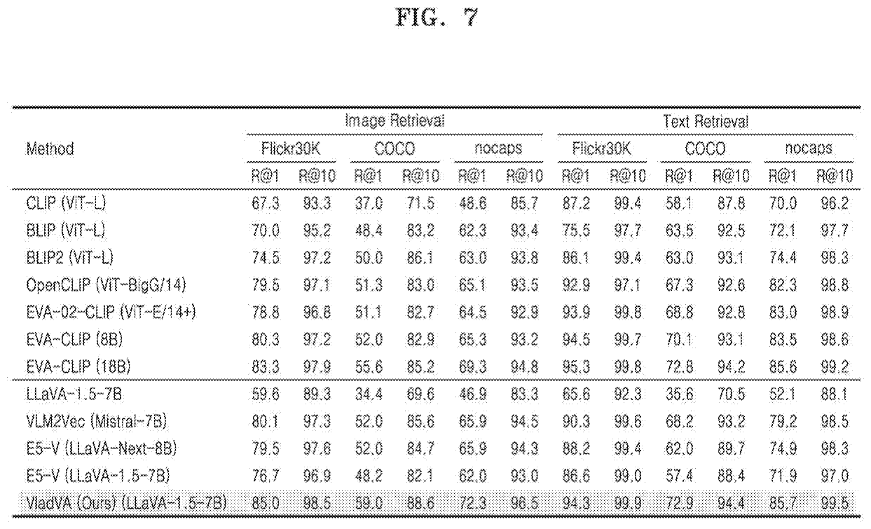

FIG. 7 illustrates a table showing results of experiments to compare zero-shot text-image retrieval accuracy on Flickr30K, COCO and nocaps according to an embodiment of the disclosure.

As shown in FIG. 7, across all three datasets, the present aspect significantly surpasses the current state-of-the-art including models of similar size. It even outperforms the much bigger EVA-CLIP (18B) model (85.0% vs. 83.3%) on Flickr30k, (59.0% vs. 55.6%) on MS-COCO and (72.3% vs. 69.3%) on nocaps in terms of R@1 for image retrieval. Similarly, the present techniques outperform the LVLM-based E5-V model by 5.5% on Flickr30k, 7% on MS-COCO, and 6.4% on nocaps.

Image-text compositionality: Here, the focus is on the currently most challenging test sets, SugarCrepe and SugarCrepe++. For SugarCrepe++, the interest is primarily in the Image-to-Text (ITT) setting since the Text-to-Text (TOT) one evaluates the language component of the methods only.

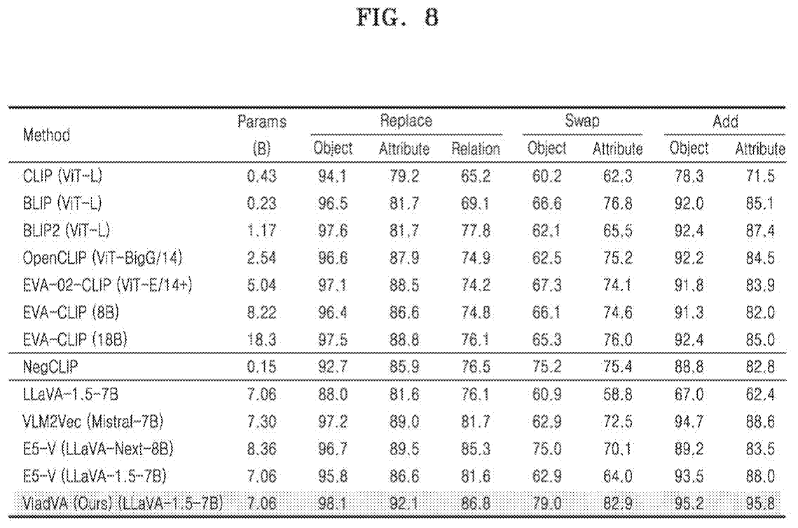

FIG. 8 illustrates a table showing results of experiments to compare the present techniques with state-of-the-art, performed on the SugarCrepe compositionality benchmark according to an embodiment of the disclosure.

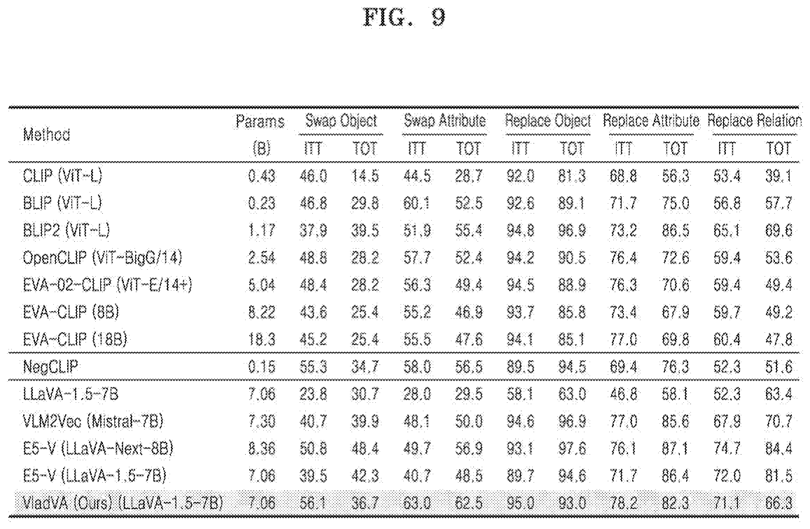

FIG. 9 illustrates a table showing results of experiments to compare the present techniques with state-of-the-art, performed on the SugarCrepe++ compositionality benchmark according to an embodiment of the disclosure.

As FIGS. 8 and 9 show, the present aspect is the best in both SugarCrepe and SugarCrepe++ (ITT). On SugarCrepe, the present techniques outperform the 18B EVA-CLIP model on all categories, with particularly large gains on relation replacement (76.1 vs. 86.8), attribution adding (85.0 vs. 95.8), and object swap (65.3 vs. 79.0). The last case is particularly interesting as it directly measures the bag-of-words behaviour, showcasing significant improvements offered by the present method. Additionally, the present techniques outperform the E5-V variant based on the same LLaVA-1.5-7B model that is used by the present techniques, and the one based on the heavier LLaVA-Next-8B. A similar trend is observed on SugarCreppe++ where the present techniques outperform EVA-CLIP (18B) by up to 10.9% (on object swap) and E5-V (ITT) in all but relation replacement. Thanks to its text-text training, E5-V surpasses the present method for the TOT setting, but it is noted that their loss can be readily incorporated into the present framework.

### Ablation Studies

Impact of method's components: The impact of the proposed method's components may be quantified by training on a smaller 1M subset, reporting results on SugarCrepe (averaged over each category) and on Flickr30k (R@1 for T2I and I2T).

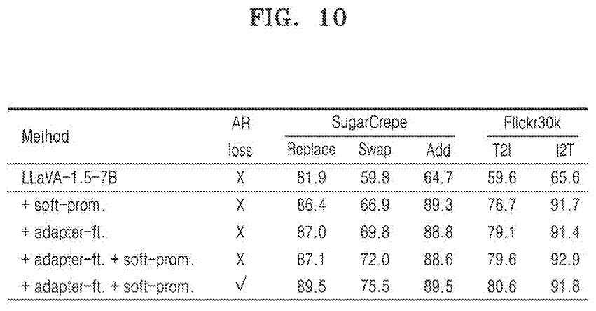

FIG. 10 illustrates a table showing impact of adaptation components and AR loss according to an embodiment of the disclosure. All models may be trained on 1M samples.

Impact of adaptation components: The impact of the efficient adaptation strategy based on soft prompting and adapter-finetuning may be measured. For simplicity, this is ablated by training using only the contrastive loss. As the results from FIG. 10 show, both components, individually and jointly, provide notable gains on top of the original LLaVA-1.5-7B model (e.g., the case of no adaptation).

While LoRA fine-tuning performs better than soft-prompting (due to its bigger capacity), the latter alone performs surprisingly well. To understand why, the changes the soft prompts undergo are analysed by finding the closest embedding in the LLM's vocabulary. This results in the following decoded sentences: “</s>‘<Summarize the provided image in one word:/$[” and, “ωaSummarize the provided text in one word:—”. The two sentences remain unchanged semantically, with the only characters changed being the ones at the start and the end of the prompt. Intuitively, this allows the model to mark/specialize the token that should gather the visual or textual evidence for discriminative tasks.

Impact of AR loss: The impact of the proposed autoregressive loss on long captions may be measured. As FIG. 10 shows, the AR loss adds a notable performance boost across all datasets tested. Finally, it is noted that using the long captions in isolation, without the proposed training strategy and loss, does not result in measurable gains.

Impact of training dataset size: Although at a relatively small scale (training is expensive due to the LVLM), here the aim is to examine whether scaling the dataset size benefits the proposed discriminative adaptation of LVLMs. Specifically, the dataset size is scaled from 1M to 8.1M samples.

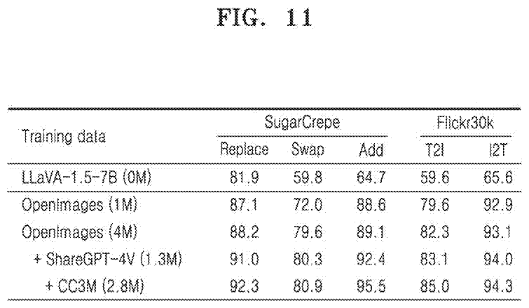

FIG. 11 illustrates a table showing impact of training data size according to an embodiment of the disclosure.

As FIG. 11 shows, steady gains are achieved across all metrics, with no signs of immediate saturation. This suggests that some potential is still left untapped, and further scaling could result in extra gains.

Thus, the present techniques provide a new framework for adapting a generative LVLM into a discriminative model, unlocking its innate capability for powerful image-text discrimination and enhanced language understanding. The framework may use both short and long captions for training the LVLM with contrastive and next-token prediction losses respectively. A parameter-efficient adaptation method may also be presented, using a combination of soft prompting and LoRA adapters. Finally, it is shown that the present aspect results in significant improvements over state-of-the-art models of similar size for image-text retrieval and compositionality benchmarks.

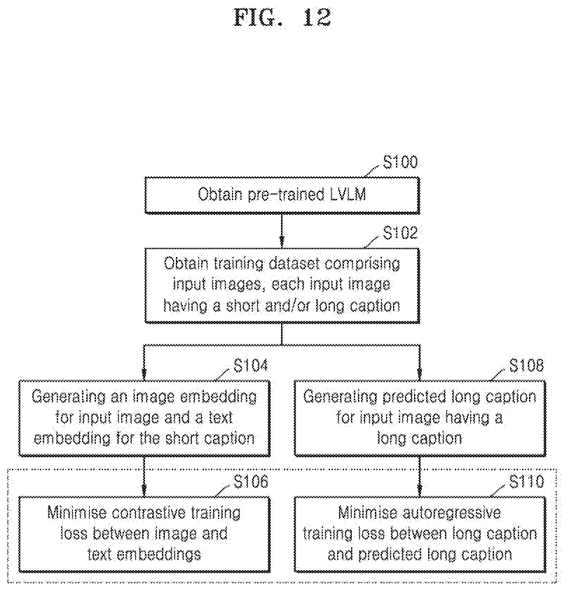

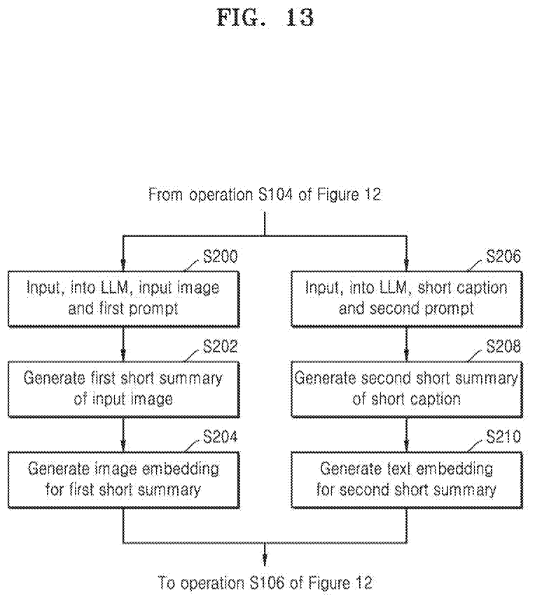

FIG. 12 illustrates a flowchart of example operations of a method for generating a discriminative large vision language model, LVLM, for performing image-based tasks according to an embodiment of the disclosure.

The method for fine-tuning a pre-trained generative LVLM may be provided. At operation S100, the method may comprise obtaining a pre-trained generative LVLM for generating images and/or text, wherein the pre-trained generative LVLM may comprise: a large language model, LLM, and a vision encoder.

At operation S102, the method may comprise obtaining a training dataset comprising input images, wherein each input image may have at least one text caption and wherein each text caption is either a short caption or a long caption.

The method may comprise training the pre-trained generative LVLM to perform discriminative image-based tasks, by: for each input image of the training dataset having a short caption: At operation S104, the method may comprise generating, using the LLM, an image embedding for the input image and a text embedding for the short caption. At operation S106, the method may comprise minimising a contrastive training loss between the generated image embedding and text embedding.

The method may comprise training the pre-trained generative LVLM to perform discriminative image-based tasks, by: for each input image of the training dataset having a long caption: At operation S108, the method may comprise generating, using the LLM, a predicted long caption for the input image. At operation S110, the method may comprise minimising an autoregressive training loss between the long caption and the predicted long caption, wherein the contrastive training loss and autoregressive training loss may be minimised jointly (as indicated by the dashed box around operations S106 and S110).

In an embodiment, the operation S102 of obtaining a training dataset comprising input images having text captions may comprise: obtaining a plurality of images; and generating the at least one caption for each image using at least one trained ML model. This may be the embodiment when input images having text captions do not readily exist. How the captions may be generated to form the training dataset is described below with reference to the Figures.

In an embodiment, the operation S102 of obtaining a training dataset comprising input images having text captions may comprise: obtaining a plurality of images, each image having a short caption that may be up to 30 tokens in length, and/or a long caption that may be greater than or equal to 200 tokens in length. It will be understood that the caption lengths may vary—the key is that there is a large difference between the short and long caption lengths to ensure effective training for both tasks.

FIG. 13 illustrates a flowchart of example operations to perform parts of the contrastive training according to an embodiment of the disclosure. As shown, the method begins when operation S104 of FIG. 12 is initiated, e.g., generating the image embedding for an input image and text embedding for the short caption of the image.

Thus, the operation (S104 in FIG. 12) of generating an image embedding for the input image may comprise: At operation S200, the method may comprise inputting, into the LLM, the input image together with a first prompt, wherein the first prompt may cause the LLM to generate a first short summary of the input image. At operation S202, the method may comprise generating, using the LLM, the first short summary of the input image. At operation S204, the method may comprise generating, using the LLM, an image embedding for the first short summary. That is, the image embedding, fᵥ, may be obtained by passing the input image alongside a handcrafted first (image) prompt through the LVLM and taking the output representation of the last token.

The first prompt may be, for example “in one word, describe the image”. Thus, inputting the input image together with a first prompt may comprise: inputting the input image together with a first prompt to generate a first single word summary of the input image.

Typically, it may not be possible to input the first prompt and image directly into the LLM and get good results. It may instead be necessary to input an initial image embedding into the LLM together with the first prompt, so that the LLM is operating on an embedding that it can understand, rather than a raw image that it may not understand. Thus, inputting the input image may comprise inputting an initial image embedding for the image into the LLM.

Preferably, the initial image embedding may be generated using the part of the LVLM that is good at processing images, e.g., the vision encoder. However, the LLM may not be able to readily understand an embedding produced by a vision encoder because the embedding is based on image features and is therefore a representation in vision/image space, but the LLM operates in text space. Thus, at operation S104/operation S200, the method may further comprise generating the initial image embedding by: generating, using the vision encoder, a vision embedding for the input image, wherein the vision embedding may encode vision features extracted from the input image by the vision encoder and wherein the vision embedding may be in a vision embedding space; and converting, using a projector module of the LVLM, the vision embedding from the vision embedding space into the initial image embedding in a textual embedding space. Accordingly, the projector module may help the LLM to understand the output from the vision encoder.

Thus, the operations to generate an image embedding, fᵥ, that encapsulates features of the image have been described. For the contrastive training, it may also be necessary to generate a text embedding, fₜ, that encapsulates features of the short caption associates with the image. The goal of the contrastive training may be to ensure that the image and text embeddings for image-text pairs are close to each other in textual embedding space.

When the text caption is a short caption, generating (at operation S104) a text embedding for the short caption may comprise: At operation S206, the method may comprise inputting, into the LLM, the short caption together with a second prompt to generate a second short summary of the short caption. At operation S208, the method may comprise generating, using the LLM, the second short summary of the short caption. At operation S210, the method may comprise generating, using the LLM, a text embedding for the second short summary. Thus, the LLM does not generate a text embedding for the short caption itself, but for a summary based on the short caption.

The second prompt may be, for example “in one word, describe the text”. Thus, inputting the short caption together with a second prompt may comprise: inputting the short caption together with a second prompt to generate a second single word summary of the short caption.

As shown in FIG. 13, once the embeddings have been generated, the process may return to operation S106 of FIG. 12 in order to minimise any difference between the image embedding generated at operation S204 and the text embedding generated at operation S210.

Thus, returning to FIG. 12, generally speaking, the operation S106 of minimising a contrastive training loss, [symbol] , may comprise: calculating a similarity between the generated image embedding and text embedding for each image having a short caption; and minimising the contrastive training loss by adjusting parameters of the LLM to increase the calculated similarity between the generated image embeddings and text embeddings. For example, the image and text embeddings must be close if they are semantically similar, and this may be enforced using a symmetric image-text and text-image contrastive loss.

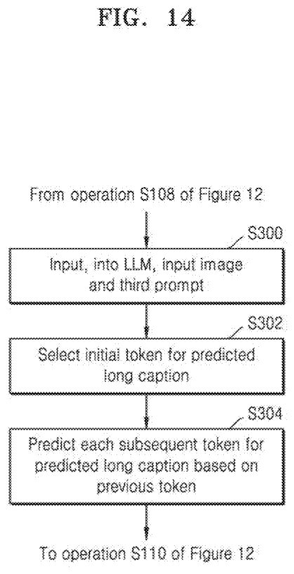

FIG. 14 illustrates a flowchart of example operations to perform parts of the autoregressive training according to an embodiment of the disclosure. As shown, the method begins when operation S108 of FIG. 12 is initiated, e.g., generating the predicted long caption for input image having a long caption.

For the autoregressive training, it may be desirable for the LLM to be able to predict a long caption for an input image, where a long caption for the input image already exists. That is, the training may be used to cause the LLM to generate a long caption that is substantially similar to the existing long caption, though the LLM is only provided with the image and not the existing long caption.

Thus, the operation (S108 in FIG. 12) of generating, using the LLM, a predicted long caption for the input image may comprise: At operation S300, the method may comprise inputting, into the LLM, the input image together with a third prompt to generate a predicted long caption of the input image. The third prompt may be, for example “describe the image in detail”.

The long caption may be generated using a next-token prediction technique. Thus, it may be necessary to start the process using a <BOS> (beginning of sentence) indicator, which is used to signal the initial token for the start of generation. Thus, generating (at operation S108), using the LLM, a predicted long caption for the input image may comprise: At operation S302, the method may comprise selecting an initial token (<BOS>) for the predicted long caption based on the input image and the third prompt, wherein the predicted long caption may comprise a sequence of a plurality of tokens. At operation S304, the method may comprise predicting each subsequent token in the sequence for the predicted long caption based on the previous token in the sequence.

As shown in FIG. 14, once the embeddings have been generated, the process may return to operation S110 of FIG. 12 in order to minimise any difference between the predicted long caption and the pre-existing long caption of the image.

Thus, returning to FIG. 12, generally speaking, the operation S110 of minimising an autoregressive training loss, [symbol] , may comprise: minimising an autoregressive training loss by adjusting parameters of the LLM to increase a probability that each token in the predicted long caption matches each token in the long caption for the input image. For example, the autoregressive training loss may enable the LLM to learn from long captions, by predicting each and every token correctly. The loss may be guided by the existing long caption for the input image. That is, it may be desirable for the existing long caption and the generated long caption to be similar.

Thus, generating (operation S104), using the LLM, an image embedding for the input image and a text embedding for the short caption may comprise using a low-rank adapter for the LLM. As a result, minimising a contrastive training loss (operation S106) using the generated image embedding and text embedding may comprise adjusting parameters of the low-rank adapter rather than the LVLM parameters directly.

Similarly, generating (operation S108), using the LLM, a predicted long caption for the input image may comprise using a low-rank adapter for the LLM. As a result, minimising an autoregressive training loss (operation S110) between the long caption for and the predicted long caption may comprise adjusting parameters of the low-rank adapter.

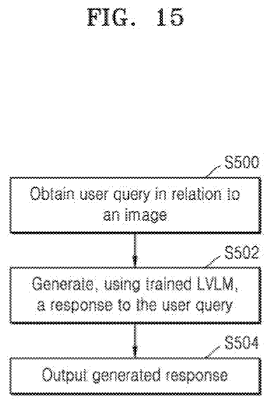

FIG. 15 illustrates a flowchart of example operations of a method for using a trained discriminative large vision language model, LVLM, on a electronic device, wherein the LVLM has been trained using the methods described herein (e.g., with reference to FIGS. 12 to 14). At operation S500, the method may comprise obtaining a user query in relation to an image. At operation S502, the method may comprise generating, using the trained LVLM to process the user query, a response to the user query. At operation S504, the method may comprise outputting the generated response.

One example task for the trained LVLM is to describe or caption images. This may be useful for many purposes, such as for helping visually-impaired people to navigate different situations. Therefore, image captioning may help to improve content accessibility for people by describing the images to them.

In this example, obtaining (at operation S500) a user query in relation to an image may comprise obtaining an image and a user text query to describe the image. Then, operation S502 may comprise: generating, using the trained LVLM to process the user query, a long caption. Operation S504 may comprise outputting the generated long caption to a display of the electronic device. In an embodiment, the generated long caption may be read out to the user via a speaker of the electronic device.

One example task for the trained LVLM is to retrieve or search for images based on a user query (e.g., “find pictures of my dog running in a park”). This may help users to find images they have captured and which are stored in their image stores/photo galleries. Many users have thousands of images, and so searching for them by viewing each image would be very time-consuming.

In this example, obtaining (at operation S500) a user query in relation to an image may comprise obtaining a user text query to retrieve at least one image from a plurality of images stored on the electronic device. Then, operation S502 may comprise: generating, using the trained LVLM to process the user query, a text embedding for the user text query; and searching the plurality of images to identify an image having an image embedding that is most similar to the generated text embedding. Operation S504 may comprise outputting the identified image to a display of the electronic device.

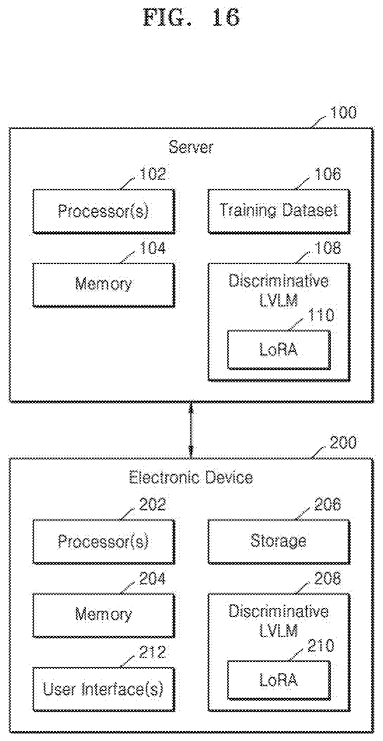

FIG. 16 illustrates a block diagram of a system for fine-tuning a pre-trained LVLM and using the fine-tuned LVLM according to an embodiment of the disclosure. The system may comprise a server 100 for transforming a generative large vision language model, LVLM, into a discriminative large vision language model, LVLM 108 using a training dataset 106. The discriminative LVLM 108 may be fine-tuned using a low-rank adapter, LoRA 110, as explained above.

The server 100 may comprise at least one processor 102 coupled to memory 104 and arranged for implementing the methods described herein. The memory 104 may store instructions that, when executed by the at least one processor 102 individually or collectively, cause the at least one processor to perform the methods described herein.

The electronic device 200 may be able to use a trained discriminative large vision language model, LVLM. The electronic device may therefore comprise the fine-tuned LVLM (e.g., discriminative LVLM) 208 (with LoRA 210) that has been fine-tuned by the server. As explained above, the electronic device 200 may comprise at least one processor 202 coupled to memory 204 and arranged for implementing the methods described herein. The electronic device 200 may comprise storage 206 for storing images (e.g., captured or otherwise obtained via the electronic device), and at least one user interface 212 (e.g., display, audio output, etc.)

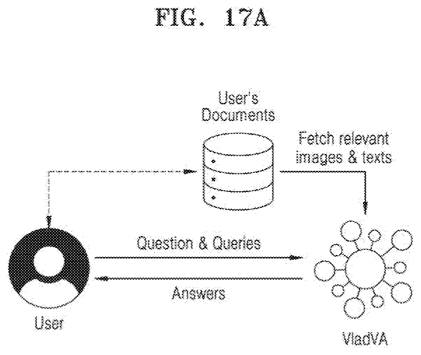

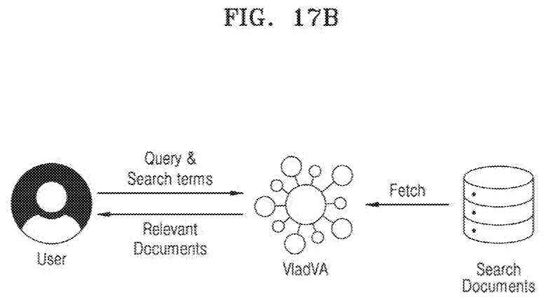

FIGS. 17A and 17B illustrate a block diagram of example application using the VladVA according to an embodiment of the disclosure.

Referring to FIG. 17A, the VladVA may be used for retrieval augmented visual chatbots. In the retrieval augmented visual chatbots, the VladVA model may be capable of functioning as both a generative model and a discriminative model. The user may provide a set of text and image documents, and may query the assistant with different questions about these documents.

In a discriminative mode, the VladVA model may first fetch relevant texts or images corresponding to the user's question. In a generative mode, the VladVA model may then generate an answer based on the information contained in the fetched relevant texts or images.

Referring to FIG. 17B, the VladVA may be used for multi-modal search. In the multi-modal search, the VladVA may be used solely in a discriminative mode, functioning as a highly effective and flexible search model.

Given a set of documents including images, texts, or both, and a user query, which may be an image or a text query, the VladVA model may be capable of fetching relevant documents, ordered by their degree of relevance to the user's query.

During an inference phase, the VladVA model may selectively operate in the discriminative mode or the generative mode depending on the application context. The VladVA may be implemented on a large vision-language model (LVLM) including a vision encoder, a projection module, and a language model (LLM) component, which are jointly fine-tuned through contrastive and generative objectives. In the discriminative mode, the VladVA may process both image and text inputs by projecting them into a shared embedding space and computing a similarity score, for example using cosine similarity, between the respective embeddings. Based on the computed similarity scores, the VladVA may retrieve and rank documents, images, or texts that are most relevant to the given query. This operation may utilize the discriminative capability obtained through contrastive fine-tuning, enabling accurate image-text alignment and retrieval.

In the generative mode, the VladVA may employ its autoregressive decoding capability to produce a natural language response conditioned on the visual and textual information retrieved during the discriminative stage. The generative process may use the model's pre-trained LVLM pathways, refined through the generative loss applied on long captions, to ensure that the produced text remains coherent, context-aware, and compositionally rich. The model may thus generate an answer, summary, or description grounded in the relevant multimodal content identified earlier.

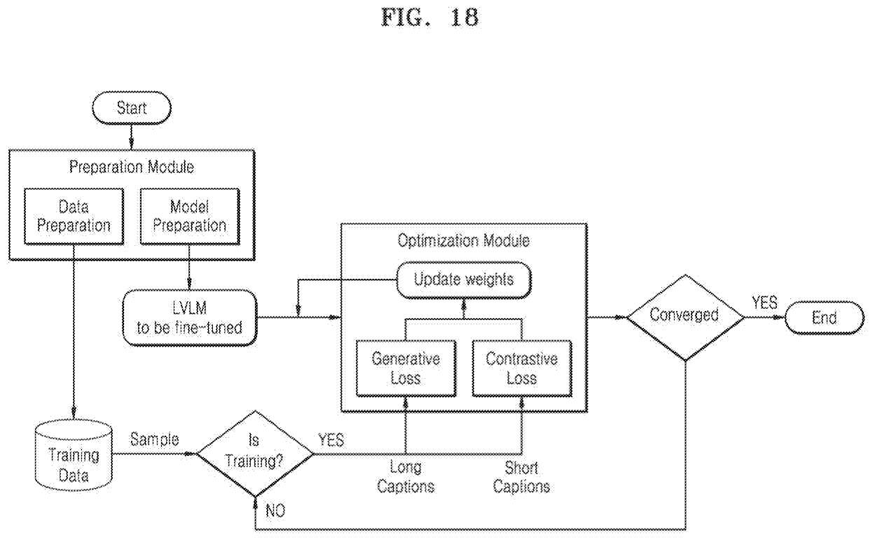

FIG. 18 illustrates a flowchart of a method for training the VladVA according to an embodiment of the disclosure.

Referring to FIG. 18, the VladVA may include a preparation module and an optimization module.

The preparation module may include operations for data preparation and model preparation. In an embodiment, the preparation module may utilize mixed data containing both long and short image captions, thereby ensuring diverse input granularity during training. The preparation module may also include modifications to a pre-trained generative model so as to make the model adaptable for discriminative tasks, thereby enhancing its flexibility.

The optimization module may include a generative loss applied over the long captions to preserve the model's original compositional capabilities, and a contrastive loss applied to the short captions to integrate new discriminative capabilities into the fine-tuned model. At each training operation of the optimization module, an image and two corresponding descriptions, including a short caption and a long caption, may be sampled. The training objective may be computed as a combination of two objectives, both of which may be necessary for unlocking strong discrimination and compositionality capabilities of the VladVA model.

The optimization module may update weights based on both the generative loss and the contrastive loss. In particular, the optimization module may perform gradient-based updates over the network parameters that are involved in the fine-tuning process, including the soft prompts and LoRA adapter modules. The pre-trained parameters of the base LVLM may remain frozen or partially frozen to maintain the generative foundation, while the learnable parameters introduced by the fine-tuning process may be iteratively adjusted. Through the updates guided by the contrastive loss, the VladVA model may improve alignment between the image embeddings and the short caption embeddings, thereby enhancing its discriminative capability. Concurrently, the updates guided by the generative loss may preserve and refine the model's compositional capability by maintaining coherent generation of long captions. As the optimization progresses, the VladVA model may reach a balanced representation that integrates both discriminative and generative strengths, resulting in a fine-tuned model capable of performing retrieval and generation tasks with improved multimodal understanding.

In an embodiment, a contrastive loss may be applied to align the image and short caption embeddings for feature alignment and discriminative learning. In an embodiment, a cross-entropy next-token loss may be applied over the long caption to maintain the generative model's original compositional abilities.

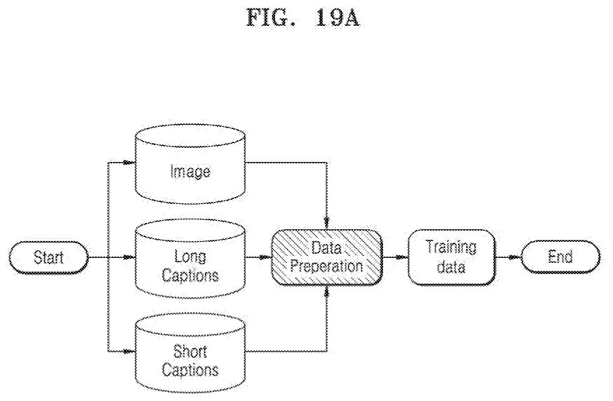

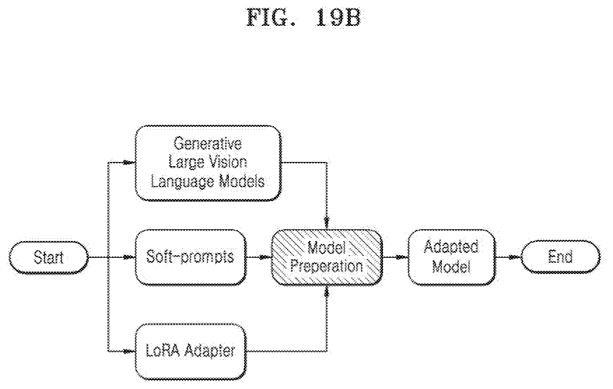

FIGS. 19A and 19B illustrate a flowchart of a method for data and model preparation according to an embodiment of the disclosure.

Referring to FIG. 19A, a method for data preparation may be illustrated. In the data preparation process, each training image may be represented by both a short caption and a long caption, as opposed to the standard practice of training with only a single type of input. The use of both long and short captions may ensure that the model is exposed to diverse input granularity, thereby improving its generalization and compositional learning capabilities.

Referring to FIG. 19B, a method for model preparation may be illustrated. In the model preparation process, the pretrained generative LVLM (large vision-language model) may be enhanced with both soft prompts at the input level and a LoRA adapter module at the network level so as to adapt the model for discriminative tasks in the subsequent training stage.

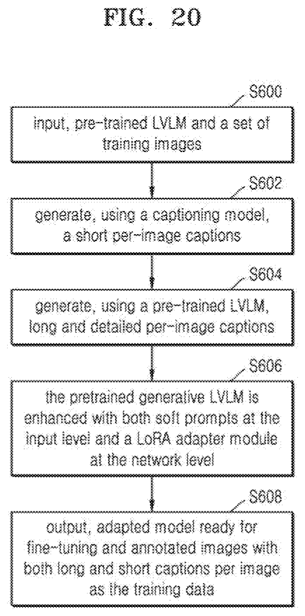

FIG. 20 illustrates a flowchart of a method for a preparation module of the VladVA according to an embodiment of the disclosure.

Referring to FIG. 20, a method for a preparation module may be provided.

At operation S600, the method may include inputting pre-trained LVLM and a set of training images. At operation S602, the method may include generating, using a captioning model (e.g., BLIP2), a short per-image captions. At operation S604, the method may include generation, using a pre-trained LVLM (e.g., ShareGPT-4), long and detailed per-image captions. At operation S606, the method, wherein the pretrained generative LVLM may be enhanced with both soft prompts at the input level and a LoRA adapter module at the network level. At operation S608, the method may include outputting, adapted model ready for fine-tuning and annotated images with both long and short captions per image as the training data

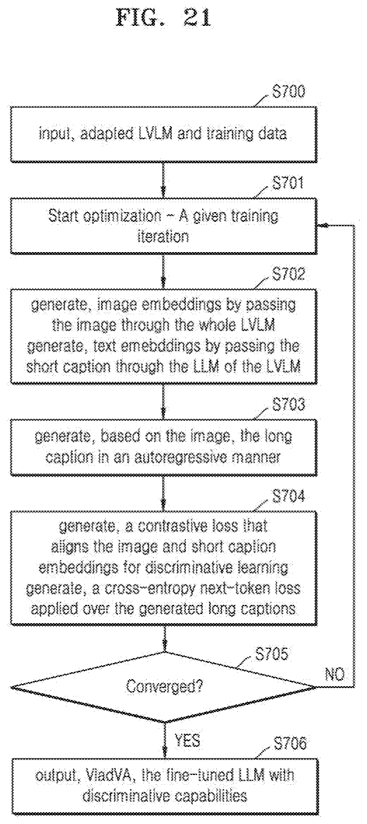

FIG. 21 illustrates a flowchart of a method for an optimization module of the VladVA according to an embodiment of the disclosure.

Referring to FIG. 21, a method for an optimization module may be provided.

At operation S700, the method may include inputting an adapted LVLM and a set of training data comprising images and corresponding captions. At operation S701, the method may include starting optimization for a given training iteration. At operation S702, the method may include generating image embeddings by passing the image through the entire LVLM, and generating text embeddings by passing the corresponding short caption through the language model (LLM) component of the LVLM. At operation S703, the method may include generating, based on the image input, a long caption in an autoregressive manner. At operation S704, the method may include generating a contrastive loss that aligns the image and short caption embeddings for discriminative learning, and generating a cross-entropy next-token loss applied over the generated long captions to preserve the generative compositional capabilities of the model. At operation S705, the method may include determining whether the optimization has converged; if convergence is achieved, proceeding to operation S706, otherwise returning to operation S701. At operation S706, the method may include outputting the VladVA, representing a fine-tuned LVLM with enhanced discriminative capabilities.

In an embodiment, at operation S705, determining convergence may include monitoring a joint objective composed of the contrastive loss (applied on short captions) and the cross-entropy next-token loss (applied on long captions), and declaring convergence when both losses exhibit a non-increasing trend within a tolerance over a predefined window of training iterations.

In an embodiment, determining convergence may include verifying that the contrastive loss plateaus while the cross-entropy next-token loss remains within a bound that preserves compositional capabilities, thereby preventing degradation of the generative pathway during discriminative adaptation.

In an embodiment, determining convergence may include computing a similarity score (e.g., cosine similarity) between image embeddings and short caption embeddings and declaring convergence when a batch-level retrieval metric (e.g., Recall@1 measured on image-to-text or text-to-image within the training iteration) saturates together with stability of the joint objective.

In an embodiment, determining convergence may include evaluating the average entropy of the output distribution at the next-to-be-predicted token location (summary token) and declaring convergence when the entropy stabilizes while the cumulative variance of the image and text embedding matrices remains spread out, indicating discriminative embeddings that retain generative diversity.

In an embodiment, determining convergence may include analyzing the attention map between the summary token and vision tokens and declaring convergence when the attention maps densify and then stabilize across training iterations, which indicates that the LVLM gathers evidence from relevant image regions consistently for discrimination.

In an embodiment, determining convergence may include a multi-criteria rule in which (i) the contrastive loss does not improve beyond a threshold, (ii) the cross-entropy next-token loss does not deteriorate beyond a threshold, and (iii) the similarity score distribution between matched and mismatched pairs is separated by a margin within the shared embedding space.

In an embodiment, when parameter-efficient adaptation is used, determining convergence may include monitoring the stability of the learnable parameters associated with soft prompting and LoRA adapters while keeping pre-trained LVLM parameters frozen or partially frozen; convergence may be declared when the updates of the soft prompts and LoRA adapters fall below a threshold while the joint objective remains stable.

In an embodiment, determining convergence may include alternating checks in discriminative mode and generative mode during training: a discriminative check based on retrieval alignment using cosine similarity over image-text pairs with short captions, and a generative check based on autoregressive long caption generation; convergence may be declared only when both checks satisfy respective stability criteria.

According to an embodiment of the disclosure, a method for generating a LVLM is provided.

In an embodiment, the method, wherein generating the image embedding for the input image may comprise inputting, into the LLM, the input image together with a first prompt, wherein the first prompt may cause the LLM to generate a first short summary of the input image; generating, using the LLM, the first short summary of the input image; and generating, using the LLM, an image embedding for the first short summary.

In an embodiment, the method, wherein inputting the input image together with the first prompt may comprise inputting the input image together with a first prompt to generate a first single word summary of the input image.

In an embodiment, the method, wherein inputting the input image may comprise inputting an initial image embedding for the input image into the LLM.

In an embodiment, the method, wherein the initial image embedding may be generated by: generating, using the vision encoder, a vision embedding for the input image, wherein the vision embedding may encode vision features extracted from the input image by the vision encoder and wherein the vision embedding may be in a vision embedding space; and converting, using a projector module of the LVLM, the vision embedding from the vision embedding space into the initial image embedding in a textual embedding space.

In an embodiment, the method, wherein in case that the text caption is the short caption, generating the text embedding for the short caption may comprise inputting, into the LLM, the short caption together with a second prompt to generate a second short summary of the short caption; generating, using the LLM, the second short summary of the short caption; and generating, using the LLM, a text embedding for the second short summary.

In an embodiment, the method, wherein inputting the short caption together with the second prompt may comprise inputting the short caption together with a second prompt to generate a second single word summary of the short caption.

In an embodiment, the method, wherein minimising the contrastive training loss may comprise calculating a similarity between the image embedding and the text embedding for the each input image having the short caption; and minimising the contrastive training loss by adjusting parameters of the LLM to increase the calculated similarity between the image embedding and the text embedding.

In an embodiment, the method, wherein generating, using the LLM, the predicted long caption for the input image may comprise inputting, into the LLM, the input image together with a third prompt to generate a predicted long caption of the input image.

In an embodiment, the method, wherein generating, using the LLM, the predicted long caption for the input image may comprise selecting an initial token for the predicted long caption based on the input image and the third prompt, wherein the predicted long caption may comprise a sequence of a plurality of tokens; and predicting each subsequent token in the sequence for the predicted long caption based on a previous token in the sequence.

In an embodiment, the method, wherein minimising the autoregressive training loss may comprise minimising an autoregressive training loss by adjusting parameters of the LLM to increase a probability that each token in the predicted long caption matches each token in the long caption for the input image.

In an embodiment, the method, wherein generating, using the pre-trained LVLM, the image embedding for the input image and the text embedding for the short caption may comprise using a low-rank adapter for the LLM. The method, wherein minimising the contrastive training loss using the image embedding and the text embedding may comprise adjusting parameters of the low-rank adapter. The method, wherein generating, using the LLM, the predicted long caption for the input image may comprise using the low-rank adapter for the LLM. The method, wherein minimising the autoregressive training loss between the long caption and the predicted long caption may comprise adjusting the parameters of the low-rank adapter.

According to an embodiment of the disclosure, an electronic device including memory storing instructions and at least one processor operatively coupled to the memory and comprising processing circuitry is provided.

In an embodiment, the electronic device, wherein to generate the image embedding for the input image, the at least one processor may individually or collectively execute the instructions to cause the electronic device to: input, into the LLM, the input image together with a first prompt, wherein the first prompt may cause the LLM to generate a first short summary of the input image; generate, using the LLM, the first short summary of the input image; and generate, using the LLM, an image embedding for the first short summary.

In an embodiment, the electronic device, wherein to input the input image together with the first prompt, the at least one processor may individually or collectively execute the instructions to cause the electronic device to: input the input image together with a first prompt to generate a first single word summary of the input image.

In an embodiment, the electronic device, wherein to input the input image, the at least one processor may individually or collectively execute the instructions to cause the electronic device to: input an initial image embedding for the input image into the LLM.

In an embodiment, the electronic device, wherein the at least one processor may individually or collectively execute the instructions to cause the electronic device to: generate, using the vision encoder, a vision embedding for the input image, wherein the vision embedding may encode vision features extracted from the input image by the vision encoder and wherein the vision embedding may be in a vision embedding space; and convert, using a projector module of the LVLM, the vision embedding from the vision embedding space into the initial image embedding in a textual embedding space.

In an embodiment, the electronic device, wherein in case that the text caption is the short caption, to generate the text embedding for the short caption, the at least one processor may individually or collectively execute the instructions to cause the electronic device to: input, into the LLM, the short caption together with a second prompt to generate a second short summary of the short caption; generate, using the LLM, the second short summary of the short caption; and generate, using the LLM, a text embedding for the second short summary.

In an embodiment, the electronic device, wherein to input the short caption together with the second prompt, the at least one processor may individually or collectively execute the instructions to cause the electronic device to: input the short caption together with a second prompt to generate a second single word summary of the short caption.

### REFERENCES

Jiang et al—Ting Jiang, Minghui Song, Zihan Zhang, Haizhen Huang, Weiwei Deng, Feng Sun, Qi Zhang, Deqing Wang, and Fuzhen Zhuang. E5-v: Universal embeddings with multimodal large language models. arXiv preprint arXiv:2407.12580, 2024
Flickr30k—Peter Young, Alice Lai, Micah Hodosh, and Julia Hockenmaier. From image descriptions to visual denotations: New similarity metrics for semantic inference over event descriptions. Transactions of the Association for Computational Linguistics, 2:67-78, 2014
BLIP2—Junnan Li, Dongxu Li, Silvio Savarese, and Steven Hoi. Blip-2: Bootstrapping language-image pre-training with frozen image encoders and large language models. In International conference on machine learning, pages 19730-19742. PMLR, 2023
ShareGPT-4V—Lin Chen, Jinsong Li, Xiaoyi Dong, Pan Zhang, Conghui He, Jiaqi Wang, Feng Zhao, and Dahua Lin. Sharegpt4v: Improving large multi-modal models with better captions. arXiv preprint arXiv:2311.12793, 2023.
LoRA—Edward J Hu, Yelong Shen, Phillip Wallis, Zeyuan AllenZhu, Yuanzhi Li, Shean Wang, Lu Wang, and Weizhu Chen. Lora: Low-rank adaptation of large language models. arXiv preprint arXiv:2106.09685, 2021
CLIP (ViT-L)—Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. In International conference on machine learning, pages 8748-8763. PMLR, 2021
BLIP (ViT-L)—Junnan Li, Dongxu Li, Caiming Xiong, and Steven Hoi. Blip: Bootstrapping language-image pre-training for unified vision-language understanding and generation. In International conference on machine learning, pages 12888-12900. PMLR,
OpenCLIP (ViT-G/14)—Christoph Schuhmann, Romain Beaumont, Richard Vencu, Cade Gordon, Ross Wightman, Mehdi Cherti, Theo Coombes, Aarush Katta, Clayton Mullis, Mitchell Wortsman, et al. Laion-5b: An open large-scale dataset for training next generation image-text models. Advances in Neural Information Processing Systems,
EVA-02-CLIP (ViT-E/14+)—Quan Sun, Yuxin Fang, Ledell Wu, Xinlong Wang, and Yue Cao. Eva-clip: Improved training techniques for clip at scale. arXiv preprint arXiv:2303.15389, 2023
EVA-CLIP (8B) and EVA-CLIP (18B)—Quan Sun, Jinsheng Wang, Qiying Yu, Yufeng Cui, Fan Zhang, Xiaosong Zhang, and Xinlong Wang. Eva-clip-18b: Scaling clip to 18 billion parameters. arXiv preprint arXiv:2402.04252, 2024
NegCLIP—Mert Yuksekgonul, Federico Bianchi, Pratyusha Kalluri, Dan Jurafsky, and James Zou. When and why vision-language models behave like bags-of-words, and what to do about it? arXiv preprint arXiv:2210.01936, 2022.
LLaVA-1.5 (7B)—Haotian Liu, Chunyuan Li, Qingyang Wu, and Yong Jae Lee. Visual instruction tuning. Advances in neural information processing systems, 36, 2024
AdamW—I Loshchilov. Decoupled weight decay regularization. arXiv preprint arXiv:1711.05101, 2017
Cosine scheduler—Ilya Loshchilov and Frank Hutter. Sgdr: Stochastic gradient descent with warm restarts. arXiv preprint arXiv:1608.03983, 2016
PyTorch—Adam Paszke, Sam Gross, Francisco Massa, Adam Lerer, James Bradbury, Gregory Chanan, Trevor Killeen, Zeming Lin, Natalia Gimelshein, Luca Antiga, et al. Pytorch: An imperative style, high-performance deep learning library. Advances in neural information processing systems, 32, 2019
DeepSpeed—Jeff Rasley, Samyam Rajbhandari, Olatunji Ruwase, and Yuxiong He. Deepspeed: System optimizations enable training deep learning models with over 100 billion parameters. In Proceedings of the 26th ACM SIGKDD International Conference on Knowledge Discovery & Data Mining, pages 3505-3506, 2020.
OpenImages—Alina Kuznetsova, Hassan Rom, Neil Alldrin, Jasper Uijlings, Ivan Krasin, Jordi Pont-Tuset, Shahab Kamali, Stefan Popov, Matteo Malloci, Alexander Kolesnikov, et al. The open images dataset v4: Unified image classification, object detection, and visual relationship detection at scale. International journal of computer vision, 128 (7): 1956-1981
CC3M (~2.8M images)—Piyush Sharma, Nan Ding, Sebastian Goodman, and Radu Soricut. Conceptual captions: A cleaned, hypernymed, image alt-text dataset for automatic image captioning. In Proceedings of the 56th Annual Meeting of the Association for Computational Linguistics (Volume 1: Long Papers), pages 2556-2565, 2018.
MS-COCO—Tsung-Yi Lin, Michael Maire, Serge Belongie, James Hays, Pietro Perona, Deva Ramanan, Piotr Dollar, and C Lawrence' Zitnick. Microsoft coco: Common objects in context. In Computer Vision-ECCV 2014: 13th European Conference, Zurich, Switzerland, Sep. 6-12, 2014, Proceedings, Part V 13, pages 740-755. Springer, 2014
nocaps—Harsh Agrawal, Karan Desai, Yufei Wang, Xinlei Chen, Rishabh Jain, Mark Johnson, Dhruv Batra, Devi Parikh, Stefan Lee, and Peter Anderson. Nocaps: Novel object captioning at scale. In Proceedings of the IEEE/CVF international conference on computer vision, pages 8948-8957, 2019
SugarCrepe—Cheng-Yu Hsieh, Jieyu Zhang, Zixian Ma, Aniruddha Kembhavi, and Ranjay Krishna. Sugarcrepe: Fixing hackable benchmarks for vision-language compositionality. Advances in neural information processing systems, 36, 2024.
SugarCrepe++—Sri Harsha Dumpala, Aman Jaiswal, Chandramouli Sastry, Evangelos Milios, Sageev Oore, and Hassan Sajjad. Sugarcrepe++ dataset: Vision-language model sensitivity to semantic and lexical alterations. arXiv preprint arXiv:2406.11171, 2024. 7

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A method for generating a large vision language model, LVLM, the method comprising:
obtaining a pre-trained LVLM for generating at least one of images or text, wherein the pre-trained LVLM comprises a large language model, LLM, and a vision encoder;
obtaining a training dataset comprising input images, wherein each input image has at least one text caption and wherein each text caption is either a short caption or a long caption; and
training the pre-trained LVLM to perform discriminative image-based tasks, by:
for each input image of the training dataset having the short caption:
generating, using the pre-trained LVLM, an image embedding for the input image and a text embedding for the short caption; and
minimising a contrastive training loss using the image embedding and the text embedding; and
for each input image of the training dataset having the long caption:
generating, using the LLM, a predicted long caption for the input image; and
minimising an autoregressive training loss between the long caption and the predicted long caption;
wherein the contrastive training loss and the autoregressive training loss are minimised jointly.

2. The method of claim 1, wherein generating the image embedding for the input image comprises:
inputting, into the LLM, the input image together with a first prompt, wherein the first prompt causes the LLM to generate a first short summary of the input image;
generating, using the LLM, the first short summary of the input image; and
generating, using the LLM, an image embedding for the first short summary.

3. The method of claim 2, wherein inputting the input image together with the first prompt comprises:
inputting the input image together with a first prompt to generate a first single word summary of the input image.

4. The method of claim 2, wherein inputting the input image comprises inputting an initial image embedding for the input image into the LLM.

5. The method of claim 4, wherein the initial image embedding is generated by:
generating, using the vision encoder, a vision embedding for the input image, wherein the vision embedding encodes vision features extracted from the input image by the vision encoder and wherein the vision embedding is in a vision embedding space; and
converting, using a projector module of the LVLM, the vision embedding from the vision embedding space into the initial image embedding in a textual embedding space.

6. The method of claim 1, wherein in case that the text caption is the short caption, generating the text embedding for the short caption comprises:
inputting, into the LLM, the short caption together with a second prompt to generate a second short summary of the short caption;
generating, using the LLM, the second short summary of the short caption; and
generating, using the LLM, a text embedding for the second short summary.

7. The method of claim 6, wherein inputting the short caption together with the second prompt comprises:
inputting the short caption together with a second prompt to generate a second single word summary of the short caption.

8. The method of claim 1, wherein minimising the contrastive training loss comprises:
calculating a similarity between the image embedding and the text embedding for the each input image having the short caption; and
minimising the contrastive training loss by adjusting parameters of the LLM to increase the calculated similarity between the image embedding and the text embedding.

9. The method of claim 1, wherein generating, using the LLM, the predicted long caption for the input image comprises:
inputting, into the LLM, the input image together with a third prompt to generate a predicted long caption of the input image.

10. The method of claim 9, wherein generating, using the LLM, the predicted long caption for the input image comprises:
selecting an initial token for the predicted long caption based on the input image and the third prompt, wherein the predicted long caption comprises a sequence of a plurality of tokens; and
predicting each subsequent token in the sequence for the predicted long caption based on a previous token in the sequence.

11. The method of claim 10, wherein minimising the autoregressive training loss comprises:
minimising an autoregressive training loss by adjusting parameters of the LLM to increase a probability that each token in the predicted long caption matches each token in the long caption for the input image.

12. The method of claim 1, wherein:
generating, using the pre-trained LVLM, the image embedding for the input image and the text embedding for the short caption comprises using a low-rank adapter for the LLM;
minimising the contrastive training loss using the image embedding and the text embedding comprises adjusting parameters of the low-rank adapter;
generating, using the LLM, the predicted long caption for the input image comprises using the low-rank adapter for the LLM; and
minimising the autoregressive training loss between the long caption and the predicted long caption comprises adjusting the parameters of the low-rank adapter.

13. An electronic device comprising:
memory storing instructions; and
at least one processor operatively coupled to the memory and comprising processing circuitry,
wherein the at least one processor individually or collectively executes the instructions to cause the electronic device to:
obtain a pre-trained LVLM for generating at least one of images or text, wherein the pre-trained LVLM comprises a large language model, LLM, and a vision encoder;
obtain a training dataset comprising input images, wherein each input image has at least one text caption and wherein each text caption is either a short caption or a long caption; and
train the pre-trained LVLM to perform discriminative image-based tasks, by:
for each input image of the training dataset having the short caption:
generate, using the pre-trained LVLM, an image embedding for the input image and a text embedding for the short caption; and
minimise a contrastive training loss using the image embedding and the text embedding; and
for each input image of the training dataset having the long caption:
generate, using the LLM, a predicted long caption for the input image; and
minimise an autoregressive training loss between the long caption and the predicted long caption;
wherein the contrastive training loss and the autoregressive training loss are minimised jointly.

14. The electronic device of claim 13, wherein to generate the image embedding for the input image, the at least one processor individually or collectively executes the instructions to cause the electronic device to:
input, into the LLM, the input image together with a first prompt, wherein the first prompt causes the LLM to generate a first short summary of the input image;
generate, using the LLM, the first short summary of the input image; and
generate, using the LLM, an image embedding for the first short summary.

15. The electronic device of claim 14, wherein to input the input image together with the first prompt, the at least one processor individually or collectively executes the instructions to cause the electronic device to:
input the input image together with a first prompt to generate a first single word summary of the input image.

16. The electronic device of claim 14, wherein to input the input image, the at least one processor individually or collectively executes the instructions to cause the electronic device to:
input an initial image embedding for the input image into the LLM.

17. The electronic device of claim 16, wherein the at least one processor individually or collectively executes the instructions to cause the electronic device to:
generate, using the vision encoder, a vision embedding for the input image, wherein the vision embedding encodes vision features extracted from the input image by the vision encoder and wherein the vision embedding is in a vision embedding space; and
convert, using a projector module of the LVLM, the vision embedding from the vision embedding space into the initial image embedding in a textual embedding space.

18. The electronic device of claim 13, wherein in case that the text caption is the short caption, to generate the text embedding for the short caption, the at least one processor individually or collectively executes the instructions to cause the electronic device to:
input, into the LLM, the short caption together with a second prompt to generate a second short summary of the short caption;
generate, using the LLM, the second short summary of the short caption; and
generate, using the LLM, a text embedding for the second short summary.

19. The electronic device of claim 18, wherein to input the short caption together with the second prompt, the at least one processor individually or collectively executes the instructions to cause the electronic device to:
input the short caption together with a second prompt to generate a second single word summary of the short caption.

20. One or more non-transitory computer-readable storage media storing one or more computer programs including computer-executable instructions that, when executed by one or more processors of an electronic device, cause the electronic device to perform operations, the operations comprising:
obtaining a pre-trained LVLM for generating at least one of images or text, wherein the pre-trained LVLM comprises a large language model, LLM, and a vision encoder;
obtaining a training dataset comprising input images, wherein each input image has at least one text caption and wherein each text caption is either a short caption or a long caption; and
training the pre-trained LVLM to perform discriminative image-based tasks, by:
for each input image of the training dataset having the short caption:
generating, using the pre-trained LVLM, an image embedding for the input image and a text embedding for the short caption; and
minimising a contrastive training loss using the image embedding and the text embedding; and
for each input image of the training dataset having the long caption:
generating, using the LLM, a predicted long caption for the input image; and
minimising an autoregressive training loss between the long caption and the predicted long caption;
wherein the contrastive training loss and the autoregressive training loss are minimised jointly.
